(19) United States
(12) Patent Application Publication
(10) Pub. No.: US 2025/0258288 A1
(43) Pub. Date: Aug. 14, 2025

(54) PASSIVE RADIO SENSING MEASUREMENTS

(71) Applicant: Lenovo (Singapore) Pte. Limited, Singapore (SG)

(72) Inventors: Seyedomid Taghizadeh Motlagh, Oberursel (DE); Ali Ramadan Ali, Kraiburg (DE); Vijay Nangia, Woodridge, IL (US)

(73) Assignee: Lenovo (Singapore) Pte. Limited, Singapore (SG)

(21) Appl. No.: 19/108,944

(22) PCT Filed: Sep. 5, 2023
(86) PCT No.: PCT/IB2023/058786

§ 371 Date: Mar. 5, 2025

Related U.S. Application Data
(60) Provisional application No. 63/403,998, filed on Sep. 6, 2022.

(51) Int. Cl. G01S 13/87; G01S 13/00; H04W 8/22

(52) U.S. Cl. CPC G01S 13/878; G01S 13/003; H04W 8/22

(57) ABSTRACT

Various aspects of the present disclosure relate to a network entity, such as a sensing receive device, receives one or more partial transmission configurations from a network device, where the one or more partial transmission configurations include a subset of parameters defining a transmission configuration of a transmit device. The sensing receive device also receives one or more transmitted signals from the transmit device according to the received one or more partial transmission configurations, and transmits a report of passive radio sensing measurements according to a report configuration, the passive radio sensing measurements determined based at least in part on the one or more transmitted signals from the transmit device according to the received one or more partial transmission configurations.

### RELATED APPLICATION

This application claims priority to U.S. Provisional Application Ser. No. 63/403,998 filed Sep. 6, 2022 entitled “Passive Radio Sensing Measurements,” the disclosure of which is incorporated by reference herein in its entirety.

### TECHNICAL FIELD

The present disclosure relates to wireless communications, and more specifically to radio sensing.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In a wireless communication network, radio sensing can be used to infer relevant environment information and improve network performance, as well as provide serving vertical use-cases. In particular, radio sensing can be used to obtain environment information from the transmission of a sensing excitation signal, reception of reflections and/or echoes of the transmitted sensing excitation signal, and processing the received reflections and/or echoes to infer the relevant environment information.

### SUMMARY

The present disclosure relates to methods, apparatuses, and systems that support passive radio sensing measurements. The techniques described in this disclosure provide solutions for addressing how passive sensing receive node measurements can be adjusted and/or separated for different transmissions (i.e., transmissions from different nodes) at the sensing receive node, and how the passive sensing measurement results generation (at the sensing receive node) and aggregation (at the network) can be coordinated by the network. Accordingly, the implementations described in this disclosure provide a number of improvements and advantages, including a partial transmission configuration indication to a sensing receive node; configuration and reporting of passive sensing measurements based on a prior capability indication of the sensing Rx node; a configuration and indication of a persistent angle; and an indication of a reflection anchor point, with joint indication of the reflection strategy and transmission configuration. In aspects of the disclosure, the described techniques provide precise sensing of environmental attributes (e.g., objects present in the environment) by passive radio sensing and can reduce power consumption by providing radio sensing and context information for use in processing radio sensing data.

In some implementations of the method and apparatuses described herein, a sensing receive device is an apparatus that receives one or more partial transmission configurations from a network device, the one or more partial transmission configurations including a subset of parameters defining a transmission configuration of a transmit device. The sensing receive device receives one or more transmitted signals from the transmit device according to the received one or more partial transmission configurations. The sensing receive device transmits a report of passive radio sensing measurements according to a report configuration, the passive radio sensing measurements determined based on the one or more transmitted signals from the transmit device according to the received one or more partial transmission configurations.

Some implementations of the method and apparatuses described herein may further include the sensing receive device determines the passive radio sensing measurements comprising at least in part deterministic or statistical information associated with one or more environment objects and/or based on a channel state information measurement in a power domain, an angular azimuth domain, an angular elevation domain, a delay domain, and/or a doppler domain. The subset of the parameters of the one or more partial transmission configurations lacks an indication of one or more parameters. The one or more partial transmission configurations include an indication of time and frequency resources. The one or more partial transmission configurations are generated based on a union of time and frequency resources of multiple transmissions, including at least one of the multiple transmissions with different radio network temporary identifier (RNTI) values, the multiple transmissions transmitted via different transmission radiation patterns, or the multiple transmissions from different transmit devices. Alternatively or in addition, the one or more partial transmission configurations are generated based on transmission of physical downlink channels that include at least one of data signals or control signals, downlink reference signal transmissions, physical uplink channels that include at least one of the data signals or the control signals, uplink reference signal transmissions, physical sidelink channels that include at least one of the data signals or the control signals, and/or sidelink reference signal transmissions. Alternatively or in addition, the one or more partial transmission configurations are generated based on transmissions via transmit devices in external systems, including one or more of a Wi-Fi system, a television broadcast system, a digital video broadcasting terrestrial (DVBT) system, or a digital video broadcasting satellite (DVBS) system.

Additionally, the sensing receive device receives the report configuration that indicates generating and transmitting the report, where the report configuration includes a set of time, frequency, and beam resources for transmitting the report, criteria for transmitting the report, and/or a type of information included in the report. The sensing receive device transmits a capability indication to at least one of perform one or more types of the passive radio sensing measurements, report the passive radio sensing measurements, or receive the one or more partial transmission configurations. The sensing receive device receives a sensing measurement configuration from the network device, and the passive radio sensing measurements are performed according to the sensing measurement configuration and the received one or more partial transmission configurations. The passive radio sensing measurements include a receive energy measurement at one or more azimuth angular points, azimuth angular segments, elevation angular points, and/or elevation angular segments.

Additionally, the sensing measurement configuration includes an indication of a partial power angular spectra (PAS), where an energy of a subset of angular points and/or angular segments are known; an indication of a partial delay profile, where a delay and/or a relative delay of a delay space is known; an angular region of interest according to a coordinate system accessible to the apparatus for the passive radio sensing measurements; and/or a delay region of interest relative to a time-reference accessible to the apparatus for the passive radio sensing measurements. The passive radio sensing measurements include a relative delay measurement of received transmitted signal reflections. The passive radio sensing measurements include an identified pattern associated with at least two of the partial transmission configurations, and the sensing receive device performs additional passive radio sensing measurements based on the identified pattern, and reports the identified pattern and the additional passive radio sensing measurements. The sensing measurement configuration includes criteria for determination of the identified pattern, and the sensing measurement configuration includes an indication of a validity time duration for a passive radio sensing measurement.

Additionally, the sensing receive device receives anchor reflection points information that includes a reflection strategy or reflection characteristics of an incident wave at an anchor reflection point; a time resource pattern of the anchor reflection point that reflects incidence wave energy from the one or more transmitted signals towards the apparatus; a joint time and frequency resource pattern of the anchor reflection point that reflects incidence wave energy from the one or more transmitted signals towards the apparatus; location information of the anchor reflection point; and/or corresponding transmissions indicated by a time-frequency pattern for which the anchor reflection point receives or reflects a minimum energy towards the apparatus. The anchor reflection points information is received as a joint indication or a separate indication of one or more of the anchor reflection points, one or more reflection strategies, and/or one or more transmission configurations. The joint indication includes at least an indication of one or more pairs of the one or more partial transmission configurations and the anchor reflection points.

In some implementations of the method and apparatuses described herein, a sensing controller device is an apparatus that receives capability information from one or more sensing receive devices, where the capability information indicates a capability of a sensing receive device to perform passive radio sensing measurements. The sensing controller device transmits one or more partial transmission configurations to a first subset of the one or more sensing receive devices to indicate a radio frequency transmission configuration for performing the passive radio sensing measurements. The sensing controller device transmits one or more reporting configurations to a second subset of the one or more sensing receive devices to indicate a type of the passive radio sensing measurements, reporting transmission resources, and criteria for transmitting a report.

Some implementations of the method and apparatuses described herein may further include the sensing controller device determines the first subset of the one or more sensing receive devices to receive the one or more partial transmission configurations, and determines the second subset of the one or more sensing receive devices to receive the one or more reporting configurations. The sensing controller device receives the report of the passive radio sensing measurements from a respective one of the one or more sensing receive devices. The sensing controller device generates the one or more partial transmission configurations based at least in part on a union of time and frequency resources of multiple transmissions, including at least one of the multiple transmissions with different RNTI values, the multiple transmissions transmitted via different transmission radiation patterns, or the multiple transmissions from different transmit devices. Alternatively or in addition, the sensing controller device generates the one or more partial transmission configurations based on transmission of physical downlink channels that include at least one of data signals or control signals, downlink reference signal transmissions, physical uplink channels that include at least one of the data signals or the control signals, uplink reference signal transmissions, physical sidelink channels that include at least one of the data signals or the control signals, and/or sidelink reference signal transmissions. Alternatively or in addition, the sensing controller device generates the one or more partial transmission configurations based on transmissions via transmit devices in external systems, including a Wi-Fi system, a television broadcast system, a DVBT system, and/or a DVBS system.

### BRIEF DESCRIPTION OF THE DRAWINGS

FIG. 1 illustrates an example of a wireless communications system that supports passive radio sensing measurements in accordance with aspects of the present disclosure.

FIG. 2 illustrates an example radio sensing scenario as related to passive radio sensing measurements in accordance with aspects of the present disclosure.

FIG. 3 illustrates an example radio sensing scenario as related to passive radio sensing measurements in accordance with aspects of the present disclosure.

FIG. 4 illustrates an example of passive radio sensing and comparison-based computation for different transmission instances received at a sensing receive node, which supports passive radio sensing measurements in accordance with aspects of the present disclosure.

FIG. 5 illustrates an example of passive radio sensing and computation of a passive channel delay profile at a sensing receive node, which supports passive radio sensing measurements in accordance with aspects of the present disclosure.

FIG. 6 illustrates an example of passive radio sensing and passive sensing receive measurements with anchor point reflections, which supports passive radio sensing measurements in accordance with aspects of the present disclosure.

FIGS. 7 and 8 illustrate an example of a block diagram of devices that supports passive radio sensing measurements in accordance with aspects of the present disclosure.

FIGS. 9 through 12 illustrate flowcharts of methods that support passive radio sensing measurements in accordance with aspects of the present disclosure.

### DETAILED DESCRIPTION

Radio sensing is an expected feature of cellular wireless networks, both as a mechanism to improve network performance, as well as enabling to serve vertical use-cases. In particular, radio sensing obtains environment information by the transmission of a sensing excitation signal (e.g., a sensing reference signal (RS)) from a network or UE entity), referred to herein as a sensing transmit (Tx) node; reception of the reflections and/or echoes of the transmitted sensing excitation signal from the environment by a network or a UE entity, referred to herein as a sensing receive (Rx) node; and/or by processing of the received reflections and inferring relevant information from the environment.

Apart from the approaches based on coherent knowledge of the transmitted sensing signal (e.g., performing sensing measurements based on transmission and reception of a reference signal (RS), where the transmitted RS is known at the sensing Rx node), a sensing Rx node can utilize the received signals from any transmission source for the purpose of sensing measurement, where a transmitted signal is not known to the sensing Rx node. The sensing measurements are referred to herein as passive sensing. Similar to how the visual system of a person obtains a picture of surrounding objects and the environment utilizing the existing visible-frequency-range illuminations, passive sensing via radio frequency (RF) waves enables a sensing Rx node to obtain information about the environment without knowing the transmitted signals (e.g., by directional power estimation or via correlation-based methods).

In this regard, although the non-coherent measurement paradigm relaxes the role of the network for coherently defining the transmitted signals for the sensing Rx node, the network performs a coordinator and aggregator role in enabling the sensing Rx node to adjust and separate the passive sensing measurements from different RF illumination sources. This includes enabling separate power-angular spectra measurements for different illumination and/or reflection sources, including downlink and uplink transmissions in the network and/or known reflection points, without exposing the data embedded within the transmitted signals to the sensing Rx node. Furthermore, the network adjusts the passive sensing measurements according to the sensing need and sensing Rx node capability, collects the performed passive measurements, and aggregates the obtained information in order to use the performed passive measurements in the obtained overall picture.

Aspects of the techniques described in this disclosure provide solutions for addressing how the passive sensing Rx node measurements can be adjusted and/or separated for different transmissions (i.e., transmissions from different nodes) at the sensing Rx node, and how the passive sensing measurement results generation (at the sensing Rx node) and aggregation (at the network) can be coordinated by the network. Accordingly, the implementations described in this disclosure provide a number of improvements and advantages, including a partial transmission configuration indication to a sensing Rx node; configuration and reporting of passive sensing measurements based on a prior capability indication of the sensing Rx node; a configuration and indication of a persistent angle; and an indication of a reflection anchor point, with joint indication of the reflection strategy and transmission configuration.

Utilizing the collected radio sensing information, a sensing receive device can identify that there is a persistent angle of reception from a particular direction, and therefore know the location of an environment object causing a reflected transmission. Notably, this information has been obtained without further resource expenditure because reference signal are not transmitted to obtain the radio sensing information. The determined passive radio sensing measurements can be transmitted to a network device (e.g., sensing controller device) or server, which can then form a bigger picture of the environment, such as where objects that reflect transmissions are located, from the passive radio sensing measurements received from several sensing receive devices (e.g., network nodes implemented for the sensing receive). Further, the sensing receive devices are closer to the environment objects, and a UE for instance, can determine and/or know the location of nearby environment objects. The passiveness aspect enables energy efficiencies because the passive process obtains the radio sensing information without consuming additional reference signal transmission power and resources.

Aspects of the present disclosure are described in the context of a wireless communications system. Aspects of the present disclosure are further illustrated and described with reference to device diagrams and flowcharts.

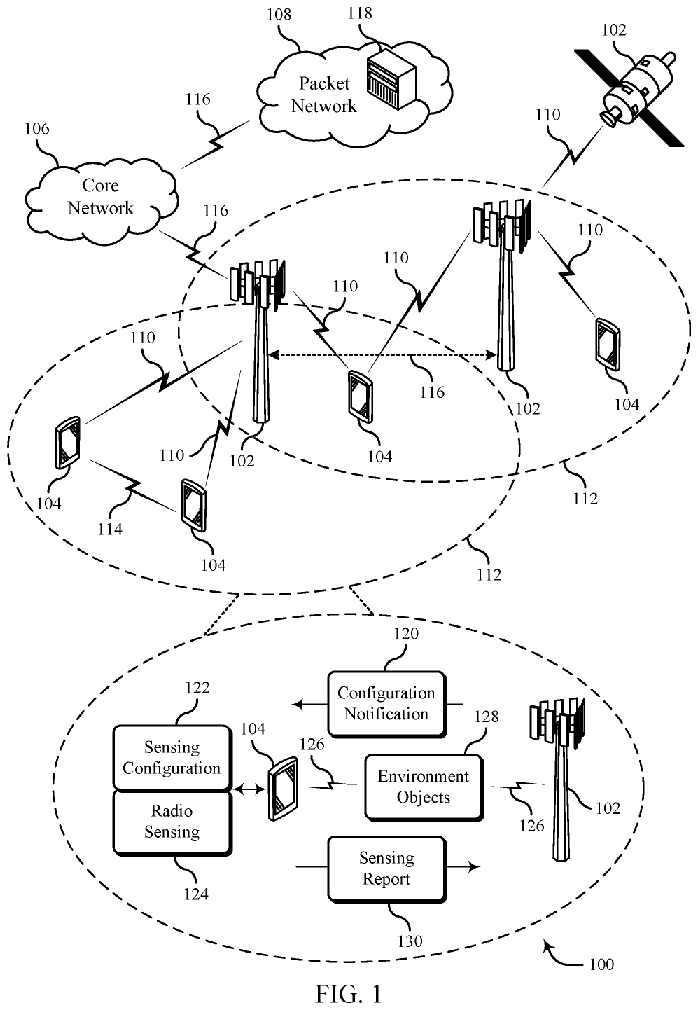

FIG. 1 illustrates an example of a wireless communications system 100 that supports passive radio sensing measurements in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHz-52.6 GHz), FR3 (7.125 GHZ-24.25 GHZ), FR4 (52.6 GHz-114.25 GHz), FR4a or FR4-1 (52.6 GHz-71 GHz), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the network entities 102 and the UEs 104 are operable to implement various aspects of passive radio sensing measurements, as described herein. For instance, a network entity 102 represents a sensing transmit node (“sensing Tx node” or “sensing transmit device” or “transmit device”) and the UE 104 represents a sensing receiver node (“sensing Rx node” or “sensing receive device”). This is not to be construed as limiting, however, and a variety of different network node types and network node implementations may be utilized as part of the disclosed implementations.

For example, the network entity 102 generates a configuration notification 120 and transmits the configuration notification 120 to the UE 104. The configuration notification 120, for instance, includes various radio sensing-related configuration information, such as known attributes of objects and/or scenarios of interest, processing configuration information for use in processing passive radio sensing measurements, a reporting configuration for reporting the passive radio sensing measurements, and so forth. In at least one implementation, the configuration notification 120 references configuration information using indices to a codebook that includes fields that describe different objects and/or scenarios of interest. Detailed examples of different instances and/or types of radio sensing-related information that can be included in the configuration notification 120 are discussed throughout this disclosure.

The UE 104 receives the configuration notification 120 and implements (e.g., performs and/or executes) sensing configuration 122 to configure different radio sensing-related logic and behaviors of the UE 104 based at least in part on the configuration notification 120. The sensing configuration 122, for instance, configures sensing, processing, reporting logic, and/or behaviors of the UE 104 and is based at least in part on the configuration notification 120. According to the sensing configuration 122, the UE 104 executes radio sensing 124 (e.g., passive radio sensing measurements). The radio sensing 124, for example, is based on reference signals 126 that are transmitted by the network entity 102 and received by the UE 104, such as directly and/or as reflected transmission signals. The radio sensing 124 can be utilized to detect environment objects 128 (e.g., objects of interest and/or objects located in the general network environment) that affect propagation of the reference signals 126, such as via signal interference, signal reflection, etc., caused by the environment objects 128. As further detailed below, the radio sensing 124 can utilize known object information included as part of the sensing configuration 122 to identify and/or confirm identity of the environment objects 128.

Based at least in part on the radio sensing 124 and/or processing of passive radio sensing measurements obtained by the radio sensing 124, the UE 104 generates a sensing report 130 and transmits the sensing report 130 to the network entity 102. The sensing report 130 can include various types of information, such as sensing measurements generated by the radio sensing 124, processed sensing measurements, sensing configuration 122 information used by the UE 104 to generate and/or process the passive radio sensing measurements, and so forth. In at least one implementation, the sensing report 130 is generated and/or transmitted according to reporting configuration information included as part of the sensing configuration 122. The network entity 102, for instance, specifies reporting configuration information in the configuration notification 120 to be used by the UE 104 to generate the sensing report 130.

In aspects of passive radio sensing measurements, and with reference to the features defining UE capabilities for radio sensing, a UE can perform as a sensing Tx for a sensing task associated with a sensing RS, defined via a set of supported sensing RS patterns. The supported sensing RS patterns include (but are not limited to) a supported time-domain resource pattern for sensing RS (e.g., a maximum supported length of the sensing RS in time domain, maximum number of symbols or symbol density for sensing RS transmission, maximum supported power/energy for sensing RS transmission, etc.). A supported frequency-domain resource pattern for sensing RS (e.g., a maximum supported bandwidth of the sensing RS in a frequency domain, maximum number of resource element (REs) or RE density for sensing RS transmission, maximum supported power/energy for sensing RS transmission within a symbol, slot, and/or a radio frame, etc.).

Additionally, a supported joint time-frequency domain resource pattern for sensing RS (e.g., a maximum supported number of total REs per radio frame for sensing RS transmission, maximum supported power and/or energy for sensing RS transmission within a symbol, slot, and/or a radio frame, the supported frequency hopping patterns, etc.). Supported spatial filters, beams, and/or maximum supported number of simultaneously used spatial beams for sensing RS transmission. Supported guard interval or cyclic prefix (CP) overhead for sensing symbols within sensing RS transmission. Supported computation and/or determination for choosing the sensing RS resource pattern among a set of possible patterns for sensing RS transmission. Supported computation and/or determination methods for choosing the sensing RS sequence among a set of possible sequences for sensing RS transmission. Supported sequence generation strategies and/or the supported sets of sequence-generation defining parameters for sensing RS transmission. Supported sequence-to-resources mapping-defining parameter set for sensing RS pattern generation for transmission.

Example features for defining UE capabilities for sensing, where the UE acts as a sensing Rx for a sensing task associated with a sensing RS, can be defined via a set of supported sensing RS patterns. The supported sensing RS patterns include (but are not limited to) supported time-domain resource pattern for sensing RS reception (e.g., a maximum supported length of the sensing RS in time domain, maximum number of symbols or symbol density for sensing RS reception, etc.). A supported frequency-domain resource pattern for sensing RS reception (e.g., a maximum supported bandwidth of the sensing RS in frequency domain, maximum number of REs or RE density for sensing RS reception, etc.). A supported joint time-frequency domain resource pattern for sensing RS reception (e.g., the maximum number of total REs per radio frame for sensing RS reception, the supported frequency hopping patterns for sensing RS reception, etc.). Supported spatial filters, beams, and/or maximum number of simultaneously used spatial beams for sensing RS reception. Supported guard interval and/or CP overhead for sensing symbols within sensing RS reception. Supported detection and/or determination for an unknown (e.g., partially unknown) received sensing RS resource pattern among a set of possible patterns for sensing RS reception. Supported detection and/or determination for an unknown (e.g., partially unknown) received sensing RS sequence among a set of possible sequences. Supported sequence generation strategies for sensing RS transmission. Supported sequence-to-resources mapping-defining parameter set for sensing RS reception.

Example features for defining UE capabilities for sensing, where the UE acts jointly as a sensing Rx and sensing Tx (e.g., in a full-duplex with simultaneous transmission and reception) for a sensing task associated with a sensing RS can be defined via a set of the supported sensing RS patterns. The supported sensing RS patterns include (but are not limited to) supported time-domain resource pattern for sensing RS joint transmission and reception. Supported frequency-domain resource pattern for sensing RS joint transmission and reception. Supported joint time/frequency-domain resource pattern including supported frequency hopping patterns for sensing RS joint transmission and reception. Supported transmit and receive beam combinations for sensing RS joint transmission and reception. Supported transmit power, e.g., average transmit power during sensing, maximum average transmit power during sensing in any of the slots, maximum transmit power during any transmit symbol, total sensing RS energy, for sensing RS joint transmission and reception. Features for supported transmit power for sensing which are defined specific to a transmit beam or Tx/Rx beam combination supported for joint sensing RS transmission and reception. Features defining allowed combinations of the supported set of sensing RS for transmission and the supported set of sensing RS for reception.

Example features for defining UE capabilities for sensing RS multiplexing can include (but are not limited to) a number of sensing RSs that can be multiplexed within a same radio frame and/or exist at the same time (e.g., exist when other ones are started and before the other ones are ended). Type of data and/or control channels or other RSs that can coexist with a sensing RS (e.g., exist after the channel and/or RS starts and before the channel and/or RS ends). Support of discrete Fourier transform (DFT) spreading on the sensing RS and/or a multiplexed sensing RS. Additionally for all the above, a supported type of multiplexing.

Example features for defining UE capabilities for sensing measurements, where the UE operates as sensing Rx can be defined via a set of supported measurement types. The supported measurement types include (but are not limited to) supported methods and/or computational models for sensing measurement (e.g., time-domain processing for time-of-flight estimation, CP-OFDM-based doppler and/or range estimation, available computational and/or artificial intelligence (AI) models for sensing measurements). Support for distance and/or range estimation, supported dynamic range of the object distance for estimation, supported distance estimation resolution. Support for object speed estimation, supported dynamic range of the object speed for estimation, supported speed estimation resolution. Support for angular estimation (e.g., direction of arrival (DoA) estimation), supported dynamic range of DoA for estimation, supported DoA estimation resolution. A maximum number of simultaneously supported objects for sensing measurements. Support for measurement features defined as a combination of any of the above features (e.g., support of DoA estimation for the objects with a specific distance dynamic range and a specific distance resolution).

Example features for defining UE capabilities for sensing measurements reporting, where the UE operates as sensing Rx can be defined via a set of supported measurement reporting types. The supported measurement reporting types include (but are not limited to) types of the supported message and/or reporting (e.g., compression of the measurements, estimated parameters, event-based reporting with a defined criterion, etc.). Duration that a measurement message can be stored by the UE before transmission and/or reporting. Supported reporting criterion (e.g., comparison of an estimated distance with a threshold, and/or computational models for checking a reporting criteria). Supported compression types for a reporting message.

With reference to sensing QoS, and for particular radio sensing tasks, information elements that specify sensing QoS and/or sensing information type include (but are not limited to) sensing information type and QoS for sensing information. The sensing information type, in one or more implementations, is a type of information to be obtained via a sensing procedure and can be included in a request message. This includes an indication of a request for object and/or blockage detection, material and/or composite estimation, tracking and/or ranging of an object of interest, estimating the speed of an object of interest, etc. In some implementations, requested information can be defined explicitly to facilitate scheduling and/or a proper response determination by the network.

The QoS for sensing information, in one or more implementations, QoS parameters for the requested sensing information is included in a request message (e.g., by a UE). Examples of this sensing QoS information include (but are not limited to) latency, reliability/accuracy, request importance, and security/privacy. Latency is the tolerable latency requirement for the accomplishment of the requested sensing operation. The measurable time duration may be defined as the time-difference from the transmission of the request or reception of the request by the network to one or more of the reception of the response from the network, reception of a sensing RS transmitted in response to the UE request, accomplishment of the sensing procedure, or reception and/or recovery of the intended sensing information by the UE, etc.

With reference to the reliability/accuracy, information on the accuracy of the obtained sensing information can be defined, such as via one or more of tolerable probability of false alarm for detection within an object and/or area of interest, specified probability of detection for detection within an object and/or area of interest, and/or tolerable error measure for parameter estimation (e.g., estimation of speed or distance of an object of interest). With reference to request importance, in some implementations, an indication of the importance (e.g., significance) of the requested information is also included in the request message, such as a different (e.g., separate) information element relative to other QoS descriptions for sensing. The indication of importance, for example, indicates a priority of the network for responding positively to the requested service. A UE, for instance, may include in the request message a priority identifier and/or class for different types of requests. With reference to security/privacy, in some implementations, a sensing operation is requested to accompany measures for protecting the sensing information, such as information pertaining to signal propagation and/or reflection from an object and/or area of interest that may be used by an unauthorized third-party. A type of the security measure may be included in the request message, such as for object of interest sensing information protection, area of interest sensing information protection, and/or requesting-UE identity protection together with a specified level of security (e.g., as an integer number defining a specified security level).

With reference to the radio sensing scenarios described for passive radio sensing measurements, network-based and UE-based (sidelink-based) radio sensing operations include proposed solutions to cover scenarios of radio sensing, where the network configures the participating sensing entities (i.e., network and UE nodes performing as sensing Tx nodes, network and UE nodes performing as sensing Rx nodes, as well as the configuration of sensing RS and necessary measurements and reporting procedures from the nodes). In this regard, the functional split between the network and the UE nodes for a specific sensing task may take various forms, depending on the availability of sensing-capable devices and the requirements of the specific sensing operation.

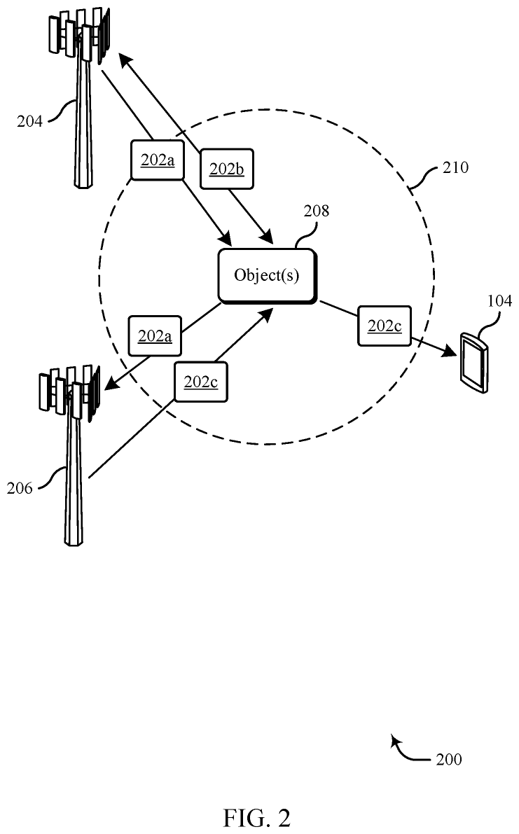

FIG. 2 illustrates example scenarios 200 for radio sensing that supports passive radio sensing measurements in accordance with aspects of the present disclosure. The scenarios 200 include a scenario 202a with a sensing Tx device as a network node 204 and a sensing Rx device as a separate network node 206, which represent different instances of network entities 102. In the scenario 202a, the sensing RS (and/or another RS used for sensing or data and/or control channels known to the network TRP nodes) is transmitted and received by network entities 102. The involvement of UE nodes can be limited, such as to aspects of interference management. The network may not utilize UEs for sensing assistance in the scenario 202a.

The scenarios also include scenario 202b with a sensing Tx device as the network node 204 and sensing Rx device as the same network node 204. In the scenario 202b, the sensing RS (and/or another RS used for sensing or the data and/or control channels known to the network TRP nodes) is transmitted and received by the same network entity 102. The involvement of UE nodes can be limited, such as to aspects of interference management. The network may not utilize UEs for sensing assistance in the scenario 202b. The scenarios also include scenario 202c with a sensing Tx device as the network node 206 and a sensing Rx device as a UE 104. In the scenario 202c, the sensing RS or other RS used for sensing is transmitted by a network entity 102 and received by one or multiple UEs 104. A network, for instance, configures the UE(s) 104 to perform as a sensing Rx node, such as according to the UE nodes capabilities for sensing and/or a specified sensing task. As part of the scenarios 202a-202c, the radio sensing is implemented to detect feature characteristics of objects 208 present in an environment 210.

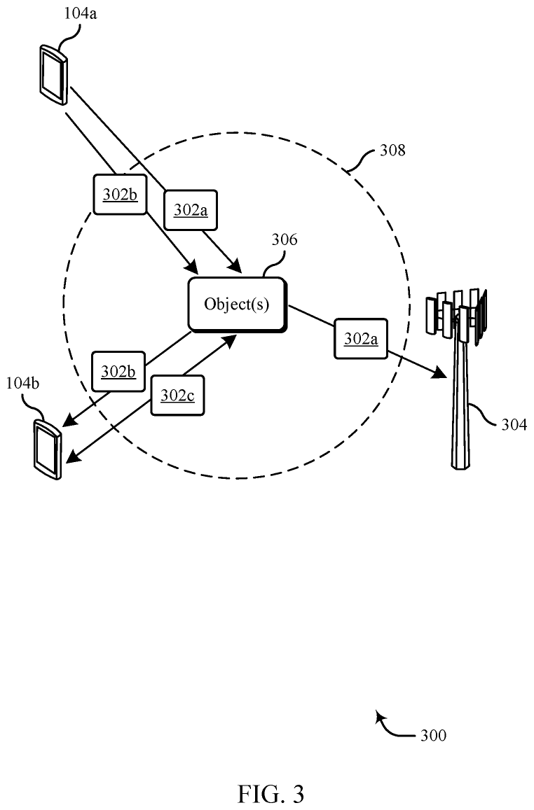

FIG. 3 illustrates example scenarios 300 for radio sensing that supports passive radio sensing measurements in accordance with aspects of the present disclosure. The scenarios 200 and 300 can represent additional and/or alternative implementations. The scenarios 300 include a scenario 302a with a sensing Tx device as a UE 104a and a sensing Rx device as a network node 304. In the scenario 302a, the sensing RS or other RS used for sensing (and/or a data and/or control channel transmitted by the UE 104a) is received by one or multiple network entities 102 (e.g., the network node 304) and transmitted by the UE 104a. A network, for instance, configures the UE 104a to perform as a sensing Tx node, such as according to the UE 104a capabilities for sensing and/or a specified sensing task.

The scenarios 300 include a scenario 302b with a sensing Tx device as the UE 104a and a sensing Rx device as a separate UE 104b. In the scenario 302b, the sensing RS or other RS used for sensing is received by one or multiple UEs 104b and transmitted by the UE 104a. In this scenario, the network and/or a UE 104 may decide on a configuration of the sensing scenario. In at least one example, a network configures the UEs 104 to perform as a sensing Tx node and/or as a sensing Rx node, such as according to the UE 104 capabilities for sensing and/or a specified sensing task. The scenarios also include scenario 302c with a sensing Tx device as the UE 104b and sensing Rx device as the same UE 104b. In the scenario 302c, the sensing RS (and/or another RS used for sensing and/or the data and/or control channels known to the UE) is transmitted by the UE 104b and received by the same UE 104b. In at least one implementation, the UE 104b and/or a network configures the sensing scenario, such as according to the UE 104 capabilities for sensing and/or a specified sensing task.

As part of the scenarios 302a-302c, the radio sensing is implemented to detect feature characteristics of objects 306 present in an environment 308. Further, the different scenarios 202 and 302 are presented for the purpose of examples only, and it is to be appreciated that implementations for passive radio sensing measurements can be employed in a variety of different scenarios, including scenarios not expressly described herein.

Further, the above scenarios are not intended to be restricted to a specific UE type, and may include any UE category and/or functionality (e.g., a UE, a roadside unit (RSU)). In any of the above scenarios, the roles depicted for a gNB and/or a UE may be replaced (with equal validity as an example of a radio sensing scenario) with a smart repeater node, an IAB node, and/or an RSU.

In aspects of passive radio sensing measurements, such as at a UE, the power angular spectra measurement, as well as the passive coherent location, is enabled and/or optimized via the network coordination and cooperation via solutions for partial transmission configuration indication to a sensing Rx node; configuration and reporting of the passive sensing measurements based on a prior capability indication of the sensing Rx node; configuration and indication of a persistent arrival angle; and/or indication of a reflection anchor point, with joint indication of the reflection strategy and transmission configuration. Aspects of the present disclosure include solutions defined for the passive sensing measurements configuration, which may be also utilized for non-passive sensing measurements (i.e., where the sensing Rx node is indicated with one or multiple of RS transmissions based on which the sensing measurements are performed), or when the combination of coherently known and partially unknown signals are available at the sensing Rx node.

Aspects of the disclosure include implementations for passive sensing Rx measurements configurations. The sensing Rx node performs sensing measurements, at least partially, based on the transmitted signals for which the transmission configurations are not known to the sensing Rx node (e.g., when the sensing Rx is indicated with the transmission time and frequency resources, but does not have access to the C-RNTI and/or other parameters necessary to obtain and decode the information within the received signal). The network may indicate to the sensing Rx node, among other configurations, the partial knowledge of the transmission configuration. As such, the sensing Rx node utilizes radio wave transmissions which may not be intended to carry data and/or RS signals for the sensing Rx node and/or may not be coherently known at the sensing Rx node for the purpose of sensing measurements and processing. The sensing Rx node, upon performing a sensing measurement based at least in part on the partially unknown transmission configurations can generate and transmit a report to the network and/or to other network nodes.

In one or more implementations, a radio sensing controller entity requests and/or receives the capability information of the sensing Rx nodes for performing passive sensing measurements, and indicates to the sensing Rx node, partial information regarding the relevant RF transmission configurations based on which sensing Rx node may perform passive sensing measurements. Additionally, the radio sensing controller indicates to the sensing Rx nodes the type of the desired passive sensing measurements, indicates the reporting transmission resources and/or reporting criteria, as well as a trigger indication by the sensing Rx node, and receives the sensing Rx node measurements. The radio sensing controller performs at least one or a combination of the above steps.

The radio sensing controller entity may be (or operate as part of) a third-party application on a UE device, a RAN node (e.g., a gNB, a smart repeater, an IAB node, a UE or gNB-RSU, or operates as part of a core network entity, such as a radio sensing management function). The partially known transmission configurations at the sensing Rx nodes are based on which of the sensing measurements the sensing Rx is implemented or configured to perform, such as related to physical downlink channels, including data and control signals, and RS signals associated with data signal demodulation for the intended information receiver (e.g., demodulation reference signal (DMRS); RS transmissions through downlink (e.g., downlink synchronization and signal block (SSB), positioning reference signal (PRS), channel state information-reference signal (CSI-RS); physical uplink channels, including data and control signals, and RS signals associated with data signal demodulation associated to an intended information transmitter (e.g., uplink DMRS); physical sidelink channels including data and control signals, and RS signals associated with data signal demodulation for the intended sidelink information receiver; RS transmissions through sidelink (e.g., sidelink synchronization signals and/or sidelink CSI-RS/sounding reference signal (SRS)); and/or transmissions via external systems with transmission configurations (e.g., transmission time-frequency resources, waveform, transmission location, and/or transmission power), at least partially known by the network and indicated to the sensing Rx node as a useful side-information (e.g., a television broadcast signal, a Wi-Fi transmission, or transmission by other operators).

In implementations, the partial knowledge of a transmitted signal includes any one or more of a bandwidth part or frequency band where the transmission is active; information on the time and/or frequency of the signal transmission (e.g., transmission symbol pattern and/or transmission RE pattern); an approximate scheduling resources associated to a scheduling grant; a duration of the transmission; transmission bandwidth; transmission power of the transmitted signal; a beam and/or angular direction of the transmitted signal; and/or a transmission node location of the transmitted signal.

The partial knowledge of the transmission configuration is defined via an approximate or a statistical measure, where the accurate and/or deterministic information is not known or may not be exposed to the sensing Rx node. This information (e.g., time-frequency resource pattern and the Tx power) can be efficiently described statistically, but may be difficult to identify exactly due to the highly dynamic scheduling operations. In some embodiments, the statistical measure includes an approximate average power of transmission over an indicated time duration, where the transmission power may not be maintained at different segments of the transmission duration. In some implementations, the indicated time-frequency resources include symbols and/or REs with no transmission. Further, the transmission may contain additional time-frequency resources other than the ones indicated to the sensing Rx node.

In implementations, the indicated time-frequency resource pattern to the sensing Rx node is generated based on the union of the scheduled transmissions of the transmitter node (e.g., to indicate to the sensing Rx node the statistically known RF illuminations from multiple approximately similar sources for the passive sensing). In some implementations, the union is generated based on the scheduled transmissions with a sufficiently large duration (e.g., a duration exceeding a threshold). Further, the union is generated based on the scheduled transmissions at different time instances. For instance, the scheduled transmissions at different time instances are known in advance by the network. Alternatively or in addition, the scheduled transmissions at different time instances are only statistically known in advance (e.g., with a probability higher than X, a time-frequency resource pattern of Y will contain Z average transmission power over the next Q subframes). In implementations, the union is generated based on the scheduled transmissions on the beams with the same, or approximately the same, beam transmission radiation pattern. The union can be generated based on the scheduled transmissions of the neighboring transmitter nodes (e.g., indicated to the sensing Rx node as a joint source of RF illumination). In some implementations, the union of the time-frequency grants are approximated via a time-frequency pattern according to a known and/or parameterized pattern (e.g., to reduce signaling overhead). In some implementations, the indicated time-frequency pattern to the sensing Rx node is determined with the consideration of the interference effect at the sensing Rx node by the concurrent transmissions (e.g., to remove the time-frequency resources at which the sensing Rx node is expected to receive an interference signal from other transmission points).

In one or more implementations, the partially known transmission configuration by which the sensing Rx node performs measurements includes one or any combination of unknown features, such as RNTI associated with the partially known transmission configuration; a transmitted signal sequence value, the sequence type used to generate the transmitted signal; a transmitted signal sequence mapping type to physical resources; a transmission time reference (e.g., only known to the extent of the initial synchronization within the CP accuracy); an exact time and/or frequency resource pattern (e.g., only a superset (separately or jointly in time domain and frequency domain) of the time symbols and RE resources in the frequency domain used in the transmission are known, such as a statistical description of the transmission time and frequency pattern is indicated, and activeness and/or transmission probability at different REs or RE blocks (e.g., a block of x1 RE and x2 time symbols), or an average transmission power at the RE blocks; an exact duration of the transmission (e.g., expected transmission duration, jointly or separately for each RE (or RE blocks), may include a measure of error variance for some implementations; an exact transmission bandwidth in terms of the number of REs (e.g., expected transmission bandwidth for one or multiple (joint) symbols, and may include a measure of error variance for some implementations; an exact beam and/or angular direction of the transmitted signal (e.g., the beam direction information of the transmitter may not be obtained based on the received partial transmission configuration, at least within a statistical or deterministic specific error margin (e.g., a minimum mean squared error of x3); and/or an exact transmission location of the transmitted signal (e.g., the location information of the transmitter may not be obtained based on the received partial transmission configuration, at least within a statistical or deterministic specific error margin (e.g., a minimum mean squared error of x4).

In one or more implementations, the partial knowledge of the transmission configuration is indicated to the sensing Rx node for the transmissions fulfilling a criterion. The criteria is determined based on the transmission, such as with a sufficiently large and a priori known transmission time-duration with a known time-frequency pattern (e.g., above a certain threshold); with a well approximated time-frequency resource according to a parameterized pattern (e.g., the time-frequency resources approximated into a pattern with a maximum number of bits describing the pattern); with a sufficiently large bandwidth; with a sufficiently large transmission power; with a sufficiently close distance towards the sensing Rx node; with a Tx beam within the angular relevance of the sensing Rx node (e.g., angle with a maximum level of deviation); and/or an approximated energy radiated towards the sensing Rx node and/or towards the area of interest for sensing or a criteria based on the combination of the above.

In one or more implementations, the criteria is indicated to the sensing Rx node (e.g., as a side information in order to assist the sensing Rx node to perform measurements). Moreover, in some implementations, the indication of the partial knowledge of the transmission configuration to the sensing Rx node is further based on the sensing Rx node capability and/or a prior indication by the sensing Rx node for the desire to receive the indication of the partial knowledge of the transmission configuration. In some implementations, the sensing Rx node capability and/or willingness to perform passive sensing is indicated to the sensing controller node as a capability information element. The capability description may include one or a combination of a type of the possible measurement and/or processing (e.g., PAS measurements, reception time-delay and/or difference profile with respect to the line-of-sight (LOS) path, or a combination thereof, such as a power angular delay profile); a measurement resolution (e.g., distance steps and/or levels in the angular azimuth, and/or an elevation domain that can be differentiated) a maximum number of points in the angular range for which the power measurement can be done; a maximum number of points in the time-delay and/or difference measurements that can be calculated; a maximum measurement time; and/or a maximum measurement storage time.

In one or more implementations, a mismatched version (e.g., intentionally erroneous version) of the transmission location and/or a partial information thereof is indicated to the sensing Rx node (e.g., only azimuth direction, or a mismatched azimuth direction together with an approximate elevation range, is indicated to the sensing Rx node). The intention is to not expose the information to the sensing Rx node, but rather, sufficiently as to be utilized for sensing measurements.

A mismatched version of the transmission direction and/or partial information thereof can be indicated to the sensing Receive (Rx) node. Further, the sensing Rx measurements can be performed based on one or a combination of the reception of the known transmitted signals at the sensing Rx node (e.g., indicated sensing RS or other RS resources at the sensing Rx node); the received signals which are transmitted according to the partially known transmission configurations at the sensing Rx node; a priori known information of the environment, obtained from the network and/or other nodes (e.g., angular power measurements, PAS or a partial PAS (for an angular segment) indicated by a neighboring node via a sidelink connection or by the network); and/or a received configuration of the sensing measurements from the network, including the type of sensing measurement and/or the type of the expected measurement report.

In implementations, the reporting of the sensing measurements are configured by the sensing controller, and the reporting configuration includes one or a combination of the set of time and frequency resources, and beam resources for the transmission of the generated report by the sensing Rx node; a criterion for the transmission of the report, based on the generated processing; and/or a type of the information included in the generated report, which can include a quantization or compression strategy of the sensing measurements outcome.

Any of the described configurations and/or indications received by the sensing Rx node, as well as the reporting of the obtained measurements by the sensing Rx node or a subset thereof, are communicated between the sensing Rx node and the sensing controller entity via the uplink, downlink, or sidelink physical data and/or control channels defined within the communication network (e.g., via NR physical broadcast channel (PBCH), physical downlink shared channel (PDSCH), physical downlink control channel (PDCCH), physical uplink shared channel (PUSCH), physical uplink control channel (PUCCH), physical sidelink broadcast channel (PSBCH), physical sidelink control channel (PSCCH), physical sidelink shared channel (PSSCH). In some implementations, one or more of the configurations and/or indications, or part of the information elements thereof, are communicated via RRC or a higher layer signaling. One or more of the configurations and/or indications, or part of the information elements thereof, are communicated between the network and the sensing Rx node via a sensing Rx node-specific downlink control information (DCI), via or a group-common DCI, or a broadcast or multicast message.

Different configurations or indications, and/or different information elements within one configuration, are communicated via different signaling means (e.g., the scheduled time-frequency resource pattern of a transmission and/or the information elements containing the angular areas of interest with respect to a commonly known or global coordinate system can be indicated via a broadcast or multicast signaling towards the sensing Rx nodes positioned in a relevant area to the transmission, whereas the obtained measurements are reported to the sensing controlling entity via a sensing Rx specific signaling (e.g., an Uplink control information element). In implementations, part of the information elements can be communicated to the sensing Rx node via the RRC or higher-layer signaling, whereas the activation of the sensing operation and the type of the processing outcome can be defined dynamically via the sensing Rx node-specific DCI (e.g., on the PDCCH) or via a group common DCI, or a MAC-CE (control element). In some implementations, one or multiple of the configurations and/or indications, or part of the information elements thereof, are communicated via NAS signaling exchange between a sensing controller as a core network entity and the sensing Rx node.

Aspects of passive radio sensing measurements as described herein also include techniques for passive PAS measurements. The passive sensing measurements at the sensing Rx node includes one or more measurements of the received power at different angle points, at different angular segments, at different beams, or a combination thereof, resulting in a power angular spectra or profile. The measurements can be performed separately for different transmission instances, according to the indicated time-frequency resources, the indicated frequency band and/or bandwidth part, or performed jointly for the collective received signal power due to multiple transmission instances.

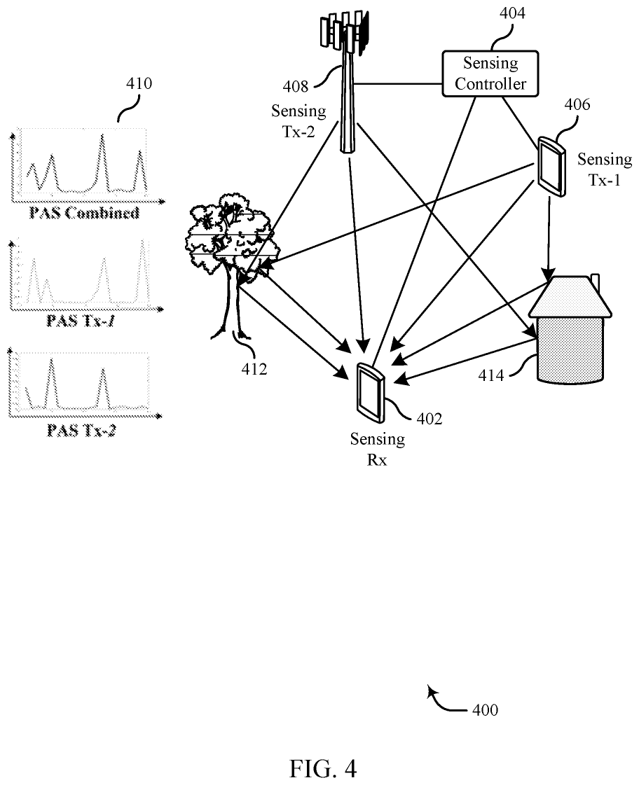

FIG. 4 illustrates an example 400 of passive radio sensing and comparison-based computation for different transmission instances received at a sensing receive node, which supports passive radio sensing measurements in accordance with aspects of the present disclosure. The PAS is obtained at a sensing Rx node 402 separately for different transmission instances to enable comparison-based computation at the sensing Rx node, or measured based on the collective received power, to reduce signaling overhead. In this example 400, a priori known PAS, partial PAS information, or an approximate PAS (e.g., including information on a subset of the angular areas) is communicated or indicated to the sensing Rx node (e.g., by the sensing controller entity 404 or by a neighboring node). In some implementations, the sensing Rx node is not configured with a coherently known RS.

In one or more implementations, almost similar Tx radiation patterns with almost similar Tx locations, or similar illumination patterns towards a subset of the perceived angular field are received by the sensing Rx node (e.g., from the sensing Tx-1 node 406 and the sensing Tx-1 node 408). When two or more transmissions result in an approximately similar PAS (e.g., where the measured power value at an angle only deviates from the true value below a deterministic or a statistical error measure, such as an absolute difference or mean squared error) or a similar partial PAS (for a subset of the angular region), such relationship is indicated to the sensing Rx nodes. In some implementations, the relation includes the information defining the area and/or condition for which the two or more transmissions result in the approximately similar PAS at the sensing Rx node.

A set of angular (azimuth/elevation) points, or angular segments are indicated by the sensing controller as the angular set of interest, for which the sensing Rx node is indicated to perform PAS calculations 410. The measurements of the sensing Rx node include a determination of persistent angles of receptions, where the persistent angles of reception include reception energy at the sensing Rx node for multiple, separate transmission instances. This indicates, for example, a close-by reflection point (e.g., reflected from environment objects 412, 414) that generates energy at a given angular point towards the sensing Rx node for a different transmission location and/or transmission beam pattern. In some implementations, a criterion for the determination and/or reporting of the persistent angles is indicated to the sensing Rx node (e.g., a minimum number of transmission instances and/or time duration for which the estimated PAS contains the same reflection angle with a (normalized) energy above an indicated threshold).

The sensing controller entity can indicate to the sensing Rx node a measurement storage or validity duration, after which the obtained PAS measurement is no longer valid. In some implementations, the validity duration is computed based on the statistics of the signal transmissions over the relevant area, the statistics of the channel (e.g., average doppler or doppler profile), as well as the velocity and/or orientation modification rate of the sensing Rx node. The sensing Rx measurements may include normalization of the received power to the total Tx power (at a corresponding transmission instance), to the total Rx power (corresponding to a transmission instance), and/or the angular segment size.

The sensing Rx is indicated with a quantization and/or compression strategy for the measured PAS. In an implementation, the measured PAS is generated using an indicated separately or jointly defined azimuth and/or elevation angular segments or grid (e.g., indicated via angular steps defining the borders and/or centers of the angular segments); using an indicated one or multiple threshold values or a table of the energy levels measured at different angular segments; and/or using an indicated compression method applied on the quantized measurements within the indicated 1-D or 2-D space of angles. In some implementations, the obtained quantized PAS is compressed and reported to the sensing controller via a bitmap compression and/or a 1-D or 2-D compression method applied on the obtained (quantized) energy levels jointly or separately at the azimuth and/or elevation angular segments.

Aspects of passive radio sensing measurements also include techniques for passive delay profile computation. The passive sensing measurement at the sensing Rx node includes measurement of the relative received path delays, for one or multiple of (separately or combined) indicated transmission resources by the sensing controller. The relative delay are measured according to a reference path (e.g., a LOS path from the transmitter to the sensing Rx node). The obtained and/or estimated relative path delays are utilized for estimating the location of the reflective paths corresponding to the delays, according to the known transmitter location and the delay of the reflective path; utilized for estimating the location of the sensing Rx node, according to the known transmitter location and the delay of the reflective path, as well as the known reflector location; and is reported to the sensing controller node, separately or jointly, with the measured received angular power corresponding to the reflection delay path, according to a received reporting criterion.

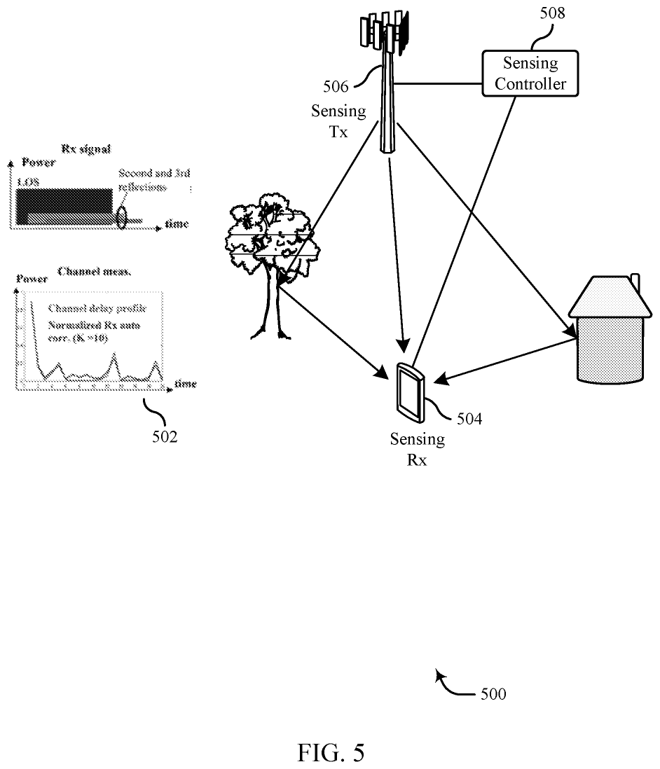

FIG. 5 illustrates an example 500 of passive radio sensing and computation of a passive channel delay profile at a sensing receive node, which supports passive radio sensing measurements in accordance with aspects of the present disclosure. The channel delay profile 502 is obtained by taking autocorrelation of the received signal, utilizing the LOS reception condition at a sensing Rx node 504 with K=10. The transmission time-frequency resource pattern is indicated to the sensing Rx node to enable the delay measurements. For example, the channel delay profile is obtained by taking an autocorrelation of the received signal, and utilizing the LOS reception condition at the sensing Rx node. The LOS condition between a sensing Tx node 506 and the sensing Rx node, and/or a criteria for the determination of the LOS condition, as well as the transmission time-frequency resource pattern, is indicated to the sensing Rx node to enable the delay measurements.

In one or more implementations, the LOS path condition towards the sensing Rx node from a transmitter node, or a criteria for the determination of the LOS path, is indicated to the sensing Rx node. In some implementations, the closely located nodes share the LOS condition towards different transmitter points (e.g., via a report to the sensing controller 508 or via an information element exchanged via the sidelink channel. The criteria for the determination of the LOS path towards the sensing Rx node from the transmitter node can include an energy threshold or a normalized energy threshold (e.g., to the total received power to the sensing Rx node from the transmission) level for the energy contained within the received signal at the corresponding angle or angular segment. The relative delay measurement can be performed based on a prior calculation of the PAS and/or determination of the angles of arrival with energy above an indicated threshold and/or the LOS path. The relative delay is measured by taking the autocorrelation of the received signal at one beam or angular segment upon the identification of the LOS reception at the sensing Rx node from an indicated transmission by the sensing controller, or by the calculation of the cross correction between the received signal at the received beam close to the measured reception angle and the beam closer to the LOS reception angle.

The calculated cross correlation value can be compared to an indicated threshold for the determination of the existence of the reflection. A relative delay margin of interest (e.g., to a LOS reception from a known direction to the sensing Rx) and/or a delay resolution of interest is indicated to the sensing Rx node according to which the delay profile is measured. The energy of the reflection path can be jointly determined via the autocorrelation or cross correlation process and quantized and/or compressed according to an indicated strategy. In implementations, the measured PAS and the power-delay profile are one or more of merged (i.e., by identifying the related angle-power-delay values to the received signal at the sensing Rx node); separately or jointly quantized according to the indicated thresholds and/or delay, power, angle separate or joint steps; compressed, according to a 1-D, 2-D, or 3D compression strategy, a 2-D bitmap compression method, and the available storage resource; stored according to the indicated storage or validity duration; and/or reported according to the indicated reporting configuration and reporting criteria by the sensing controller.

Aspects of passive radio sensing measurements also include techniques for passive sensing Rx measurements with anchor point reflections. The sensing controller indicates to the sensing Rx node, information for reflective anchor points, from which an indicated transmission may generate a reflective path towards the sensing Rx node. The information of the reflective anchor point can be utilized in the measurement of the PAS; a determination of a LOS condition between the anchor point and the sensing Rx node; the measurement of the anchor node reflection path (relative) delay, via the delay profile computation; a determination of the position of the reflective anchor point; and/or in the relative location of the sensing Rx node, according to the obtained relative delay from the anchor reflection point and the LOS path from the transmitter.

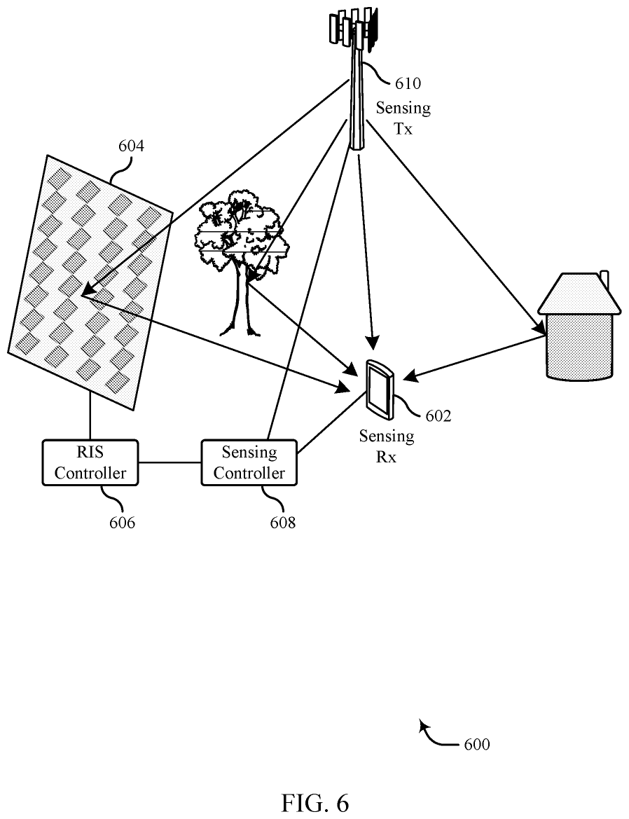

FIG. 6 illustrates an example 600 of passive radio sensing and passive sensing receive measurements with anchor point reflections, which supports passive radio sensing measurements in accordance with aspects of the present disclosure. In this example 600, the passive sensing measurements are performed based at least in part on the received reflection by a sensing Rx node 602 from an anchor reflection point 604, a reconfigurable intelligent surface (RIS) segment from an RIS controller 606, and received information by the sensing controller 608 on the anchor reflection point.

In this example 600, the anchor point 604 is at least one of a static and known environment object with a known position, a dynamic and known object with known position and movement velocity, an object with known reflection characteristics, a RIS segment, a smart repeater node, and/or an IAB node. The indicated information of the anchor point includes any one or combination of a reflection strategy and/or reflection characteristics of the incident wave at the anchor reflection point, including for example, a radar cross section (RCS) of the anchor point object, reflection characterization of the reflector point of a RIS segment for an indicated time-resource for the transmission; a time resource pattern for which the anchor reflection point reflects incidence wave energy from the indicated transmission towards the sensing Rx node, for the case of reflection point as a frequency agnostic reflector (e.g., a passive RIS segment, such as a wall); a joint time and frequency resource pattern for which the anchor reflection point reflects incidence wave energy from the indicated transmission towards the sensing Rx node (e.g., for a case of the reflection point as a smart repeater, IAB node, and a RIS with baseband processing); location information of the reflection anchor point; and/or corresponding transmissions, such as indicated by a time-frequency pattern for which the anchor point at least receives and/or reflects a minimum energy towards the relevant area to the sensing Rx measurements.

In one or more implementations, a time resource pattern is indicated, as a subset of the transmission time resources, for which the reflection anchor point reflects incident wave energy towards the sensing Rx node. The information of the one or multiple anchor points, one or multiple reflection strategies, and one or multiple transmissions or a combination thereof is indicated jointly to the sensing Rx node. In some implementations, the joint indication includes an indication of one or multiple pair of transmissions and reflection anchor points, such that the sensing Rx node expects to receive the reflection of the transmission included in the pair from the anchor point.

The sensing Rx node can be indicated to identify a pattern based at least in part on one or multiple of performed passive measurements. Upon identification of the indicated pattern, the sensing Rx node can report the indicated pattern and/or the performed measurements to the network (e.g., sensing controller) according to a prior sensing measurement configuration. In implementations, the indicated pattern includes one or more of a persistent angle, an increasing or decreasing angular energy, angular movement, and/or relative delay change. For example, a persistent angle is an active incoming angle or angular segment (e.g., energy above an indicated threshold) identified for multiple sensing Tx nodes transmissions (e.g., according to an indicated number of transmissions) and/or multiple transmissions of the same sensing Tx node. In an implementation, a persistent angle is identified as an angular segment, identified with a central angle in azimuth and elevation directions according to a known coordinate system to the sensing Rx node, and a deviation angle in both azimuth and elevation for which the received energy is above an indicated threshold for at least M number of indicated transmissions to the sensing Rx out of the indicated N number of the indicated transmissions (e.g., defined via the partial transmission configuration and/or coherent RS transmission). In implementations, a size of an angular segment is also indicated (e.g., allowing ten (10) degrees of deviation in azimuth and five (5) degrees of deviation in elevation angle, for an identified angle or angular segment as a persistent angle (e.g., in different transmissions, angle of arrivals within an indicated level of angular deviation are counted within the M). An example of an angular segment is an angle ten (10) degrees of elevation and twenty (20) degrees of azimuth, and any angle that differs from the angle no more than three (3) degrees of azimuth and no more than two (2) degrees of elevation.

With reference to the increasing or decreasing angular energy, where an angle or angular segment may or may not be identified as a persistent angle, the amount of the received energy experiences an increase or decrease according to the received configuration. In some implementations, a time window during which the pattern is measured and identified is indicated to the sensing Rx node. In some implementations, the rate of change for energy over time is indicated (e.g., which rate of energy change is to be identified and/or reported), identified, and/or reported by the sensing Rx node to the network (e.g., sensing controller).

With reference to the angular movement, such as for an angle or angular segment which may or may not be identified as a persistent angle, the sensing Rx node identified the change (e.g., increase or decrease of the angle in the azimuth, elevation, or both directions according to a known coordinate system to the sensing Rx node). In some embodiments, time window over which the pattern is identified, the rate of change for the angle over time is indicated (e.g., which rate of angular change is to be identified and/or reported), identified, and/or reported by the sensing Rx node to the network (e.g., sensing controller).

With reference to the relative delay change, such as for an angle or angular segment which may or may not be identified as a persistent angle, the sensing Rx node identifies the change of the measured relative delay corresponding to the received angle (e.g., an increase or decrease of the relative delay). In some implementations, a time window during which the pattern is to be identified, the rate of change for the delay over time is indicated (e.g., which rate and/or value of delay change is to be identified and/or reported), identified, and/or reported by the sensing Rx node to the network (e.g., sensing controller). In implementations, the sensing Rx node performs passive radio sensing measurements and reports the obtained measurements (e.g., obtained PAS measurement or a partial PAS), and Rx energy measurements at one or multiple angle or angular segments, either according to the received measurement or autonomously without receiving an indication of the type of the measurement by the network (e.g., sensing controller). In some implementations, the sensing Rx node performs the passive sensing measurements without prior indication of a partial transmission configuration of a sensing Tx node by the network (e.g., sensing controller).

A sensing Tx node 610 is indicated, as part of the received transmission configuration by the sensing Tx node, to maintain indicated transmission statistics, according to which the sensing Rx node performs the passive sensing measurements. In an implementation, this includes an indication of an average total transmission power and/or one or multiple of an average transmission power at an indicated transmission direction according to a known coordinate system to the sensing Tx node. The indication of the transmission configuration includes REs over which the sensing Tx node may transmit a signal, such that the transmission from the sensing Tx node satisfies the indicated transmission statistics.

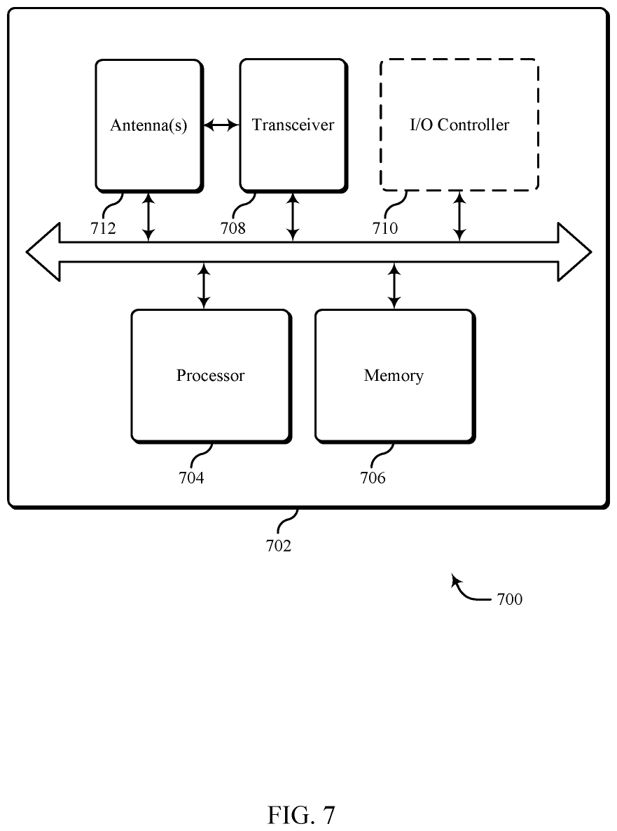

FIG. 7 illustrates an example of a block diagram 700 of a device 702 that supports passive radio sensing measurements in accordance with aspects of the present disclosure. The device 702 may be an example of a network entity 102 implemented as a sensing receive device as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706).

For example, the processor 704 may support wireless communication at the device 702 in accordance with examples as disclosed herein. The processor 704 may be configured as or otherwise support a means for receiving one or more partial transmission configurations from a network device, the one or more partial transmission configurations including a subset of parameters defining a transmission configuration of a transmit device; receiving one or more transmitted signals from the transmit device according to the received one or more partial transmission configurations; and transmitting a report of passive radio sensing measurements according to a report configuration, the passive radio sensing measurements determined based at least in part on the one or more transmitted signals from the transmit device according to the received one or more partial transmission configurations.

Additionally, the processor 704 may be configured as or otherwise support any one or combination of the method further comprising determining the passive radio sensing measurements comprising at least in part deterministic or statistical information of at least one of: a presence of one or more environment objects; a location of the one or more environment objects; a velocity of the one or more environment objects; a type of the one or more environment objects; a RCS of the one or more environment objects; one or more of a shape, a posture, a composite, or a texture of the one or more environment objects; or a CSI measurement in one or more of a power domain, an angular azimuth domain, an angular elevation domain, a delay domain, or a doppler domain. The subset of the parameters of the one or more partial transmission configurations lacks an indication of one or more parameters, including: a RNTI; a sequence type of a reference signal; a mapping of a sequence to physical resources; a modulation and coding scheme (MCS); one or more of a channel rank, a number of layers, a pre-coding matrix indicator (PMI), or a DMRS; or transmission time-frequency resources. The one or more partial transmission configurations include an indication of time and frequency resources, and wherein one of: a RE indicated in one of the one or more partial transmission configurations does not facilitate the one or more transmitted signals; or the one or more transmitted signals occur on at least one RE not indicated in one of the one or more partial transmission configurations. The one or more partial transmission configurations are generated based at least in part on a union of time and frequency resources of multiple transmissions, including at least one of the multiple transmissions with different RNTI values, the multiple transmissions transmitted via different transmission radiation patterns, or the multiple transmissions from different transmit devices. The one or more partial transmission configurations are generated based at least in part on transmission of physical downlink channels that include at least one of data signals or control signals, downlink reference signal transmissions, physical uplink channels that include at least one of the data signals or the control signals, uplink reference signal transmissions, physical sidelink channels that include at least one of the data signals or the control signals, or sidelink reference signal transmissions. The one or more partial transmission configurations are generated based at least in part on transmissions via transmit devices in external systems, including one or more of a Wi-Fi system, a television broadcast system, a DVBT system, or a DVBS system. The method further comprising receiving the report configuration that indicates generating and transmitting the report, the report configuration including at least one of a set of time, frequency, and beam resources for transmitting the report, criteria for transmitting the report, or a type of information included in the report. The method further comprising transmitting a capability indication to at least one of perform one or more types of the passive radio sensing measurements, report the passive radio sensing measurements, or receive the one or more partial transmission configurations. The method further comprising receiving a sensing measurement configuration from the network device; and performing the passive radio sensing measurements according to the sensing measurement configuration and the received one or more partial transmission configurations. The passive radio sensing measurements include a receive energy measurement at one or more azimuth angular points, azimuth angular segments, elevation angular points, or elevation angular segments. The sensing measurement configuration includes at least one of: a first indication of a partial PAS, wherein an energy of a subset of at least one of angular points or angular segments are known; a second indication of a partial delay profile, wherein at least one of a delay or a relative delay of a subset of a delay space is known; an angular region of interest according to a coordinate system accessible to the apparatus for the passive radio sensing measurements; or a relative delay region of interest relative to a time-reference accessible to the apparatus for the passive radio sensing measurements. The passive radio sensing measurements include a relative delay measurement of received transmitted signal reflections, the relative delay measurement based at least in part on one or more of: time and frequency resources associated with the received one or more partial transmission configurations; a line-of-sight direction indication associated with the received one or more partial transmission configurations; a line-of-sight condition determination associated with the received one or more partial transmission configurations; one of a first indication of a first reference receive beam, an angle of arrival of the first reference receive beam, or an angular segment of arrival of the first reference receive beam; one of a second indication of a second reference receive beam, an angle of arrival of the second reference receive beam, or an angular segment of arrival of the second reference receive beam; a third indication of a delay region for cross-correlation measurements; or a fourth indication of at least one of delay points, delay segments, or delay steps over which a cross-correlation computation is to be performed. The sensing measurement configuration includes at least one of: first angular points defining azimuth direction segments; second angular points defining elevation direction segments; third angular points jointly defining the azimuth direction segments and the elevation direction segments; a data format for the passive radio sensing measurements, the data format including format parameters that define a bitmap format, a point cloud, and a multi-dimensional array of measured values; one or more energy steps according to measured energy to be quantized; or a compression strategy of the data format. The passive radio sensing measurements include an identified pattern associated with at least two of the partial transmission configurations, and wherein the processor is configured to: perform additional passive radio sensing measurements based at least in part on the identified pattern as determined by a cross-correlation to obtain time difference of arrival (TDOA) of one or more identified persistent transmission paths; and report the one or more identified pattern persistent transmission paths and the associated additional passive radio sensing measurements. The identified pattern includes at least one of: a persistent angle indicating a close-by reflector by which the apparatus receives reflection energy for two or more different transmissions corresponding to two or more of the partial transmission configurations; one of an increasing or decreasing angular energy associated with an approaching the reflector; an angular movement associated with a moving the reflector; a function computed based on the passive radio sensing measurements; or a modification of the identified pattern. The sensing measurement configuration includes criteria for determination of the identified pattern. The sensing measurement configuration includes an indication of a validity time duration for a passive radio sensing measurement. One or more of measured energy at different angular segments, or one or more of the measured energy at different delay segments are at least one of: merged; separately or jointly quantized according to an indicated threshold and at least one of delay steps, power steps, angle separate steps, or joint steps; compressed according to at least one of a one dimensional, a two dimensional, or a three dimensional compression strategy, a two dimensional bitmap compression method, and available storage resource; stored according to an indicated storage or validity duration; or reported according to a reporting configuration and a reporting criteria. The method further comprising receiving anchor reflection points information that includes: at least one of a reflection strategy or reflection characteristics of an incident wave at an anchor reflection point; a time resource pattern of the anchor reflection point that reflects incidence wave energy from the one or more transmitted signals towards the apparatus, the anchor reflection point being a frequency agnostic reflector; a joint time and frequency resource pattern of the anchor reflection point that reflects incidence wave energy from the one or more transmitted signals towards the apparatus; location information of the anchor reflection point; or corresponding transmissions indicated by at least one of a time-frequency pattern for which the anchor reflection point receives or reflects a minimum energy towards the apparatus. The anchor reflection points information is received as at least one of a joint indication or a separate indication of one or more of the anchor reflection points, one or more reflection strategies, or one or more transmission configurations. The joint indication includes at least an indication of one or more pairs of the one or more partial transmission configurations and the anchor reflection points.

Additionally, or alternatively, the device 702, in accordance with examples as disclosed herein, may include a processor and a memory coupled with the processor, the processor configured to receive one or more partial transmission configurations from a network device, the one or more partial transmission configurations including a subset of parameters defining a transmission configuration of a transmit device; receive one or more transmitted signals from the transmit device according to the received one or more partial transmission configurations; and transmit a report of passive radio sensing measurements according to a report configuration, the passive radio sensing measurements determined based at least in part on the one or more transmitted signals from the transmit device according to the received one or more partial transmission configurations.

Additionally, the wireless communication at the device 702 may include any one or combination of the processor is configured to determine the passive radio sensing measurements comprising at least in part deterministic or statistical information of at least one of: a presence of one or more environment objects; a location of the one or more environment objects; a velocity of the one or more environment objects; a type of the one or more environment objects; a RCS of the one or more environment objects; one or more of a shape, a posture, a composite, or a texture of the one or more environment objects; or a CSI measurement in one or more of a power domain, an angular azimuth domain, an angular elevation domain, a delay domain, or a doppler domain. The subset of the parameters of the one or more partial transmission configurations lacks an indication of one or more parameters, including: a RNTI; a sequence type of a reference signal; a mapping of a sequence to physical resources; a MCS; one or more of a channel rank, a number of layers, a PMI, or a DMRS; or transmission time-frequency resources. The one or more partial transmission configurations include an indication of time and frequency resources, and wherein one of: a RE indicated in one of the one or more partial transmission configurations does not facilitate the one or more transmitted signals; or the one or more transmitted signals occur on at least one RE not indicated in one of the one or more partial transmission configurations. The one or more partial transmission configurations are generated based at least in part on a union of time and frequency resources of multiple transmissions, including at least one of the multiple transmissions with different RNTI values, the multiple transmissions transmitted via different transmission radiation patterns, or the multiple transmissions from different transmit devices. The one or more partial transmission configurations are generated based at least in part on transmission of physical downlink channels that include at least one of data signals or control signals, downlink reference signal transmissions, physical uplink channels that include at least one of the data signals or the control signals, uplink reference signal transmissions, physical sidelink channels that include at least one of the data signals or the control signals, or sidelink reference signal transmissions. The one or more partial transmission configurations are generated based at least in part on transmissions via transmit devices in external systems, including one or more of a Wi-Fi system, a television broadcast system, a DVBT system, or a DVBS system. The processor is configured to receive the report configuration that indicates generating and transmitting the report, the report configuration including at least one of a set of time, frequency, and beam resources for transmitting the report, criteria for transmitting the report, or a type of information included in the report. The processor is configured to transmit a capability indication to at least one of perform one or more types of the passive radio sensing measurements, report the passive radio sensing measurements, or receive the one or more partial transmission configurations. The processor is configured to receive a sensing measurement configuration from the network device, and wherein the passive radio sensing measurements are performed according to the sensing measurement configuration and the received one or more partial transmission configurations. The passive radio sensing measurements include a receive energy measurement at one or more azimuth angular points, azimuth angular segments, elevation angular points, or elevation angular segments. The sensing measurement configuration includes at least one of: a first indication of a partial PAS, wherein an energy of a subset of at least one of angular points or angular segments are known; a second indication of a partial delay profile, wherein at least one of a delay or a relative delay of a delay space is known; an angular region of interest according to a coordinate system accessible to the apparatus for the passive radio sensing measurements; or a delay region of interest relative to a time-reference accessible to the apparatus for the passive radio sensing measurements. The passive radio sensing measurements include a relative delay measurement of received transmitted signal reflections, the relative delay measurement based at least in part on one or more of: time and frequency resources associated with the received one or more partial transmission configurations; a line-of-sight direction indication associated with the received one or more partial transmission configurations; a line-of-sight condition determination associated with the received one or more partial transmission configurations; one of a first indication of a first reference receive beam, an angle of arrival of the first reference receive beam, or an angular segment of arrival of the first reference receive beam; one of a second indication of a second reference receive beam, an angle of arrival of the second reference receive beam, or an angular segment of arrival of the second reference receive beam; a third indication of a delay region for cross-correlation measurements; or a fourth indication of at least one of delay points, delay segments, or delay steps over which a cross-correlation computation is to be performed. The sensing measurement configuration includes at least one of: first angular points defining azimuth direction segments; second angular points defining elevation direction segments; third angular points jointly defining the azimuth direction segments and the elevation direction segments; a data format for the passive radio sensing measurements, the data format including format parameters that define a bitmap format, a point cloud, and a multi-dimensional array of measured values; one or more energy steps according to measured energy to be quantized; or a compression strategy of the data format. The passive radio sensing measurements include an identified pattern associated with at least two of the partial transmission configurations, and wherein the processor is configured to: perform additional passive radio sensing measurements based at least in part on the identified pattern; and report the identified pattern and the additional passive radio sensing measurements. The identified pattern includes at least one of: a persistent angle indicating a reflector by which the apparatus receives reflection energy for two or more different transmissions corresponding to two or more of the partial transmission configurations; one of an increasing or decreasing angular energy associated with the reflector; an angular movement associated with the reflector; a function computed based on the passive radio sensing measurements; or modification of the identified pattern. The sensing measurement configuration includes criteria for determination of the identified pattern. The sensing measurement configuration includes an indication of a validity time duration for a passive radio sensing measurement. One or more of measured energy at different angular segments, or one or more of the measured energy at different delay segments are at least one of: merged; separately or jointly quantized according to an indicated threshold and at least one of delay steps, power steps, angle separate steps, or joint steps; compressed according to at least one of a one dimensional, a two dimensional, or a three dimensional compression strategy, a two dimensional bitmap compression method, and available storage resource; stored according to an indicated storage or validity duration; or reported according to a reporting configuration and a reporting criteria. The processor is configured to receive anchor reflection points information that includes: at least one of a reflection strategy or reflection characteristics of an incident wave at an anchor reflection point; a time resource pattern of the anchor reflection point that reflects incidence wave energy from the one or more transmitted signals towards the apparatus; a joint time and frequency resource pattern of the anchor reflection point that reflects incidence wave energy from the one or more transmitted signals towards the apparatus; location information of the anchor reflection point; or corresponding transmissions indicated by at least one of a time-frequency pattern for which the anchor reflection point receives or reflects a minimum energy towards the apparatus. The anchor reflection points information is received as at least one of a joint indication or a separate indication of one or more of the anchor reflection points, one or more reflection strategies, or one or more transmission configurations. The joint indication includes at least an indication of one or more pairs of the one or more partial transmission configurations and the anchor reflection points.

The processor 704 of the device 702, such as a sensing receive device, may support wireless communication in accordance with examples as disclosed herein. The processor 704 includes at least one controller coupled with at least one memory, and is configured to or operable to cause the processor to receive one or more partial transmission configurations from a network device, the one or more partial transmission configurations including a subset of parameters defining a transmission configuration of a transmit device; receive one or more transmitted signals from the transmit device according to the received one or more partial transmission configurations; and transmit a report of passive radio sensing measurements according to a report configuration, the passive radio sensing measurements determined based at least in part on the one or more transmitted signals from the transmit device according to the received one or more partial transmission configurations.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device M02. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor 704. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (i.e., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

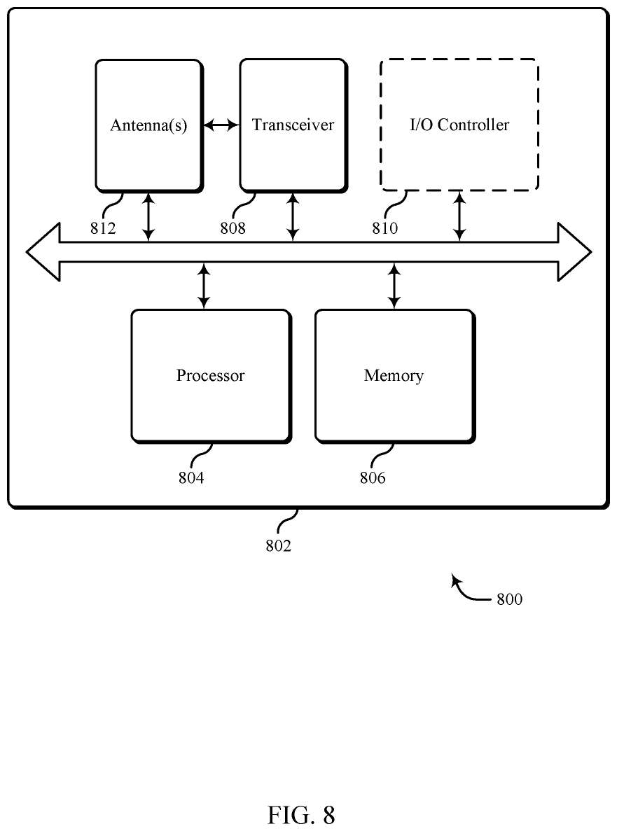

FIG. 8 illustrates an example of a block diagram 800 of a device 802 that supports passive radio sensing measurements in accordance with aspects of the present disclosure. The device 802 may be an example of a network entity 102, such as a sensing controller device as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the memory 806, the transceiver 808, or various combinations thereof or various components thereof may be examples of means for performing various aspects of the present disclosure as described herein. For example, the processor 804, the memory 806, the transceiver 808, or various combinations or components thereof may support a method for performing one or more of the operations described herein.

In some implementations, the processor 804, the memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the memory 806 coupled with the processor 804 may be configured to perform one or more of the functions described herein (e.g., executing, by the processor 804, instructions stored in the memory 806).

For example, the processor 804 may support wireless communication at the device 802 in accordance with examples as disclosed herein. The processor 804 may be configured as or otherwise support a means for receiving capability information from one or more sensing receive devices, the capability information indicating a capability of a sensing receive device to perform passive radio sensing measurements; transmitting one or more partial transmission configurations to a first subset of the one or more sensing receive devices to indicate a radio frequency transmission configuration for performing the passive radio sensing measurements; and transmitting one or more reporting configurations to a second subset of the one or more sensing receive devices to indicate a type of the passive radio sensing measurements, reporting transmission resources, and criteria for transmitting a report.

Additionally, the processor 804 may be configured as or otherwise support any one or combination of a method further comprising determining the first subset of the one or more sensing receive devices to receive the one or more partial transmission configurations; and determining the second subset of the one or more sensing receive devices to receive the one or more reporting configurations. The method further comprising receiving the report of the passive radio sensing measurements from a respective one of the one or more sensing receive devices. The method further comprising generating the one or more partial transmission configurations based at least in part on a union of time and frequency resources of multiple transmissions, including at least one of the multiple transmissions with different RNTI values, the multiple transmissions transmitted via different transmission radiation patterns, or the multiple transmissions from different transmit devices. The method further comprising generating the one or more partial transmission configurations based at least in part on transmission of physical downlink channels that include at least one of data signals or control signals, downlink reference signal transmissions, physical uplink channels that include at least one of the data signals or the control signals, uplink reference signal transmissions, physical sidelink channels that include at least one of the data signals or the control signals, or sidelink reference signal transmissions. The method further comprising generating the one or more partial transmission configurations based at least in part on transmissions via transmit devices in external systems, including one or more of a Wi-Fi system, a television broadcast system, a DVBT system, or a DVBS system.

Additionally, or alternatively, the device 802, in accordance with examples as disclosed herein, may include a processor and a memory coupled with the processor, the processor configured to receive capability information from one or more sensing receive devices, the capability information indicating a capability of a sensing receive device to perform passive radio sensing measurements; transmit one or more partial transmission configurations to a first subset of the one or more sensing receive devices to indicate a radio frequency transmission configuration for performing the passive radio sensing measurements; and transmit one or more reporting configurations to a second subset of the one or more sensing receive devices to indicate a type of the passive radio sensing measurements, reporting transmission resources, and criteria for transmitting a report.

Additionally, the wireless communication at the device 802 may include any one or combination of the processor is configured to: determine the first subset of the one or more sensing receive devices to receive the one or more partial transmission configurations; and determine the second subset of the one or more sensing receive devices to receive the one or more reporting configurations. The processor is configured to receive the report of the passive radio sensing measurements from a respective one of the one or more sensing receive devices. The processor is configured to generate the one or more partial transmission configurations based at least in part on a union of time and frequency resources of multiple transmissions, including at least one of the multiple transmissions with different RNTI values, the multiple transmissions transmitted via different transmission radiation patterns, or the multiple transmissions from different transmit devices. The processor is configured to generate the one or more partial transmission configurations based at least in part on transmission of physical downlink channels that include at least one of data signals or control signals, downlink reference signal transmissions, physical uplink channels that include at least one of the data signals or the control signals, uplink reference signal transmissions, physical sidelink channels that include at least one of the data signals or the control signals, or sidelink reference signal transmissions. The processor is configured to generate the one or more partial transmission configurations based at least in part on transmissions via transmit devices in external systems, including one or more of a Wi-Fi system, a television broadcast system, a DVBT system, or a DVBS system.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the memory 806) to cause the device 802 to perform various functions of the present disclosure.

The memory 806 may include random access memory (RAM) and read-only memory (ROM). The memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device M02. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor 804. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (i.e., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

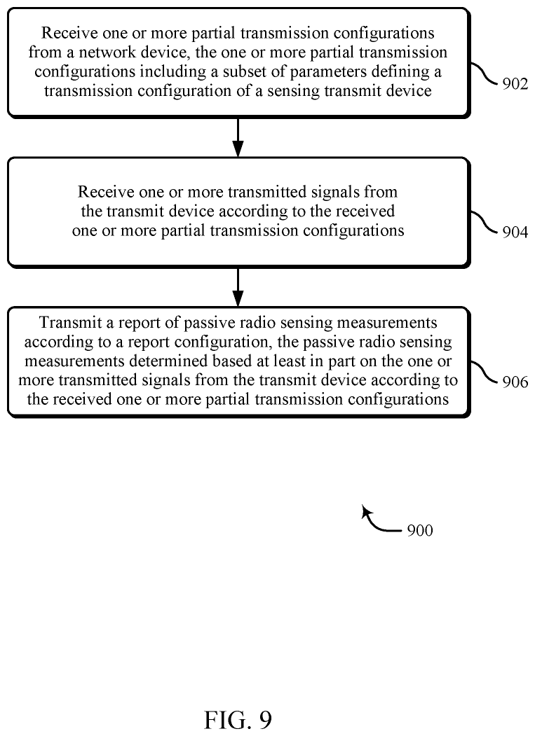

FIG. 9 illustrates a flowchart of a method 900 that supports passive radio sensing measurements in accordance with aspects of the present disclosure. The operations of the method 900 may be implemented by a device or its components as described herein. For example, the operations of the method 900 may be performed by a network entity 102, such as a sensing receive device as described with reference to FIGS. 1 through 8. In some implementations, the device may execute a set of instructions to control the function elements of the device to perform the described functions. Additionally, or alternatively, the device may perform aspects of the described functions using special-purpose hardware.

At 902, the method may include receiving one or more partial transmission configurations from a network device, the one or more partial transmission configurations including a subset of parameters defining a transmission configuration of a sensing transmit device. The operations of 902 may be performed in accordance with examples as described herein. In some implementations, aspects of the operations of 902 may be performed by a device as described with reference to FIG. 1.

At 904, the method may include receiving one or more transmitted signals from the transmit device according to the received one or more partial transmission configurations. The operations of 904 may be performed in accordance with examples as described herein. In some implementations, aspects of the operations of 904 may be performed by a device as described with reference to FIG. 1.

At 906, the method may include transmitting a report of passive radio sensing measurements according to a report configuration, the passive radio sensing measurements determined based at least in part on the one or more transmitted signals from the transmit device according to the received one or more partial transmission configurations. The operations of 906 may be performed in accordance with examples as described herein. In some implementations, aspects of the operations of 906 may be performed by a device as described with reference to FIG. 1.

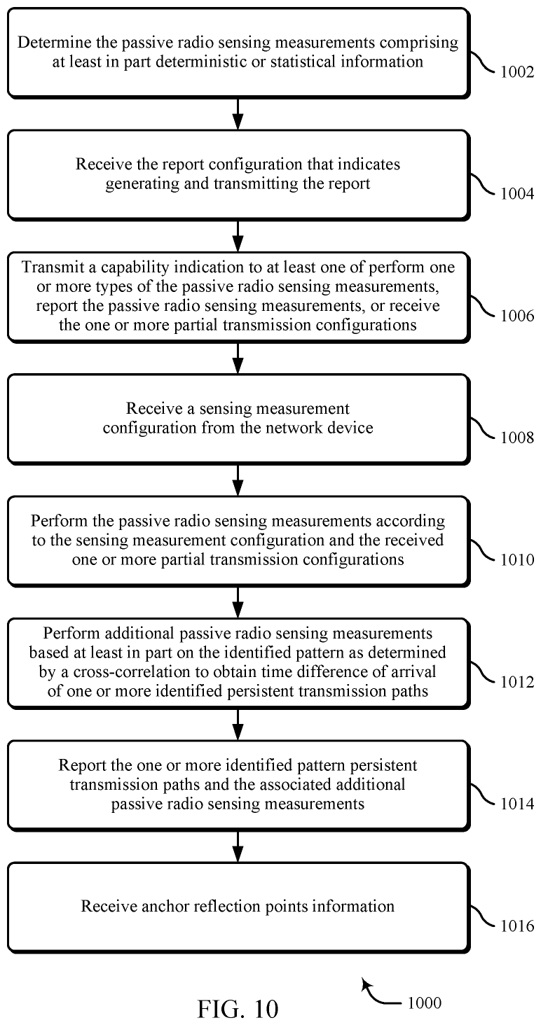

FIG. 10 illustrates a flowchart of a method 1000 that supports passive radio sensing measurements in accordance with aspects of the present disclosure. The operations of the method 1000 may be implemented by a device or its components as described herein. For example, the operations of the method 1000 may be performed by a network entity 102, such as a sensing receive device as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1002, the method may include determining the passive radio sensing measurements comprising at least in part deterministic or statistical information. The operations of 1002 may be performed in accordance with examples as described herein. In some implementations, aspects of the operations of 1002 may be performed by a device as described with reference to FIG. 1.

At 1004, the method may include receiving the report configuration that indicates generating and transmitting the report. The operations of 1004 may be performed in accordance with examples as described herein. In some implementations, aspects of the operations of 1004 may be performed by a device as described with reference to FIG. 1.

At 1006, the method may include transmitting a capability indication to at least one of perform one or more types of the passive radio sensing measurements, report the passive radio sensing measurements, or receive the one or more partial transmission configurations. The operations of 1006 may be performed in accordance with examples as described herein. In some implementations, aspects of the operations of 1006 may be performed by a device as described with reference to FIG. 1.

At 1008, the method may include receiving a sensing measurement configuration from the network device. The operations of 1008 may be performed in accordance with examples as described herein. In some implementations, aspects of the operations of 1008 may be performed by a device as described with reference to FIG. 1.

At 1010, the method may include performing the passive radio sensing measurements according to the sensing measurement configuration and the received one or more partial transmission configurations. The operations of 1010 may be performed in accordance with examples as described herein. In some implementations, aspects of the operations of 1010 may be performed by a device as described with reference to FIG. 1.

At 1012, the method may include performing additional passive radio sensing measurements based at least in part on the identified pattern as determined by a cross-correlation to obtain time difference of arrival of one or more identified persistent transmission paths. The operations of 1012 may be performed in accordance with examples as described herein. In some implementations, aspects of the operations of 1012 may be performed by a device as described with reference to FIG. 1.

At 1014, the method may include reporting the one or more identified pattern persistent transmission paths and the associated additional passive radio sensing measurements. The operations of 1014 may be performed in accordance with examples as described herein. In some implementations, aspects of the operations of 1014 may be performed by a device as described with reference to FIG. 1.

At 1016, the method may include receiving anchor reflection points information. The operations of 1016 may be performed in accordance with examples as described herein. In some implementations, aspects of the operations of 1016 may be performed by a device as described with reference to FIG. 1.

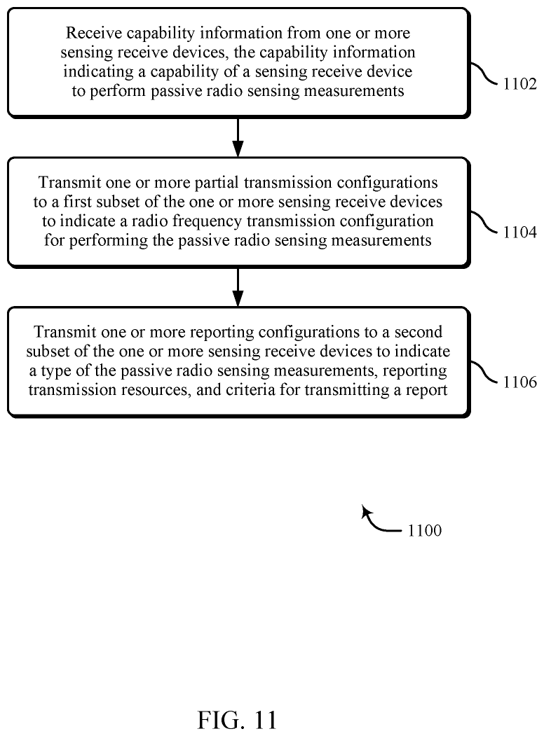

FIG. 11 illustrates a flowchart of a method 1100 that supports passive radio sensing measurements in accordance with aspects of the present disclosure. The operations of the method 1100 may be implemented by a device or its components as described herein. For example, the operations of the method 1100 may be performed by a network entity 102, such as a sensing controller device as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1102, the method may include receiving capability information from one or more sensing receive devices, the capability information indicating a capability of a sensing receive device to perform passive radio sensing measurements. The operations of 1102 may be performed in accordance with examples as described herein. In some implementations, aspects of the operations of 1102 may be performed by a device as described with reference to FIG. 1.

At 1104, the method may include transmitting one or more partial transmission configurations to a first subset of the one or more sensing receive devices to indicate a radio frequency transmission configuration for performing the passive radio sensing measurements. The operations of 1104 may be performed in accordance with examples as described herein. In some implementations, aspects of the operations of 1104 may be performed by a device as described with reference to FIG. 1.

At 1106, the method may include transmitting one or more reporting configurations to a second subset of the one or more sensing receive devices to indicate a type of the passive radio sensing measurements, reporting transmission resources, and criteria for transmitting a report. The operations of 1106 may be performed in accordance with examples as described herein. In some implementations, aspects of the operations of 1106 may be performed by a device as described with reference to FIG. 1.

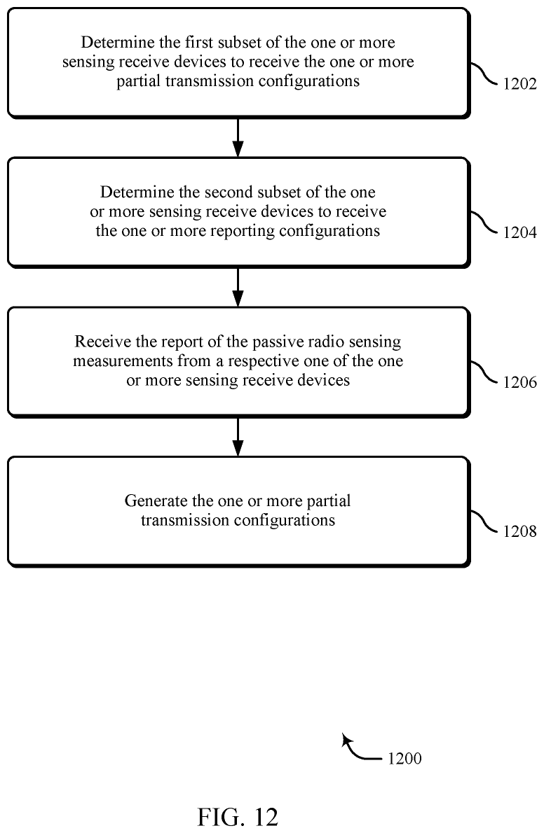

FIG. 12 illustrates a flowchart of a method 1200 that supports passive radio sensing measurements in accordance with aspects of the present disclosure. The operations of the method 1200 may be implemented by a device or its components as described herein. For example, the operations of the method 1200 may be performed by a network entity 102, such as a sensing controller device as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1202, the method may include determining the first subset of the one or more sensing receive devices to receive the one or more partial transmission configurations. The operations of 1202 may be performed in accordance with examples as described herein. In some implementations, aspects of the operations of 1202 may be performed by a device as described with reference to FIG. 1.

At 1204, the method may include determining the second subset of the one or more sensing receive devices to receive the one or more reporting configurations. The operations of 1204 may be performed in accordance with examples as described herein. In some implementations, aspects of the operations of 1204 may be performed by a device as described with reference to FIG. 1.

At 1206, the method may include receiving the report of the passive radio sensing measurements from a respective one of the one or more sensing receive devices. The operations of 1206 may be performed in accordance with examples as described herein. In some implementations, aspects of the operations of 1206 may be performed by a device as described with reference to FIG. 1.

At 1208, the method may include generating the one or more partial transmission configurations. The operations of 1208 may be performed in accordance with examples as described herein. In some implementations, aspects of the operations of 1208 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A sensing receive device for wireless communication, comprising:
at least one memory; and
at least one processor coupled with the at least one memory and configured to cause the sensing receive device to:
receive, from a network device, one or more partial transmission configurations that include a subset of parameters defining a transmission configuration of a transmit device;
receive, from the transmit device, one or more transmitted signals according to the received one or more partial transmission configurations; and
transmit a report of passive radio sensing measurements according to a report configuration, the passive radio sensing measurements determined based at least in part on the one or more transmitted signals from the transmit device according to the received one or more partial transmission configurations.

2. The sensing receive device of claim 1, wherein the at least one processor is configured to cause the sensing receive device to determine the passive radio sensing measurements comprising at least in part deterministic or statistical information of at least one of:
a presence of one or more environment objects;
a location of the one or more environment objects;
a velocity of the one or more environment objects;
a type of the one or more environment objects;
a radar cross section (RCS) of the one or more environment objects;
one or more of a shape, a posture, a composite, or a texture of the one or more environment objects; or
a channel state information (CSI) measurement in one or more of a power domain, an angular azimuth domain, an angular elevation domain, a delay domain, or a doppler domain.

3. The sensing receive device of claim 2, wherein the passive radio sensing measurements include a receive energy measurement at one or more of azimuth angular points, azimuth angular segments, elevation angular points, or elevation angular segments.

4. The sensing receive device of claim 2, wherein the passive radio sensing measurements include a relative delay measurement of received transmitted signal reflections, the relative delay measurement based at least in part on one or more of:
time and frequency resources associated with the received one or more partial transmission configurations;
a line-of-sight direction indication associated with the received one or more partial transmission configurations;
a line-of-sight condition determination associated with the received one or more partial transmission configurations;
one of a first indication of a first reference receive beam, an angle of arrival of the first reference receive beam, or an angular segment of arrival of the first reference receive beam;
one of a second indication of a second reference receive beam, an angle of arrival of the second reference receive beam, or an angular segment of arrival of the second reference receive beam;
a third indication of a delay region for cross-correlation measurements; or
a fourth indication of at least one of delay points, delay segments, or delay steps over which a cross-correlation computation is to be performed.

5. The sensing receive device of claim 1, wherein the one or more partial transmission configurations include an indication of time and frequency resources, and wherein one of:
a resource element (RE) indicated in one of the one or more partial transmission configurations does not facilitate the one or more transmitted signals; or
the one or more transmitted signals occur on at least one RE not indicated in one of the one or more partial transmission configurations.

6. The sensing receive device of claim 1, wherein the one or more partial transmission configurations are generated based at least in part on a union of time and frequency resources of multiple transmissions, including at least one of the multiple transmissions with different radio network temporary identifier (RNTI) values, the multiple transmissions transmitted via different transmission radiation patterns, or the multiple transmissions from different transmit devices.

7. The sensing receive device of claim 1, wherein the one or more partial transmission configurations are generated based at least in part on transmission of physical downlink channels that include at least one of data signals or control signals, downlink reference signal transmissions, physical uplink channels that include at least one of the data signals or the control signals, uplink reference signal transmissions, physical sidelink channels that include at least one of the data signals or the control signals, or sidelink reference signal transmissions.

8. The sensing receive device of claim 1, wherein the one or more partial transmission configurations are generated based at least in part on transmissions via transmit devices in external systems, including one or more of a Wi-Fi system, a television broadcast system, a digital video broadcasting terrestrial (DVBT) system, or a digital video broadcasting satellite (DVBS) system.

9. The sensing receive device of claim 1, wherein the at least one processor is configured to cause the sensing receive device to receive the report configuration that indicates generating and transmitting the report, the report configuration including at least one of a set of time, frequency, and beam resources for transmitting the report, criteria for transmitting the report, or a type of information included in the report.

10. The sensing receive device of claim 1, wherein the at least one processor is configured to cause the sensing receive device to transmit a capability indication to at least one of perform one or more types of the passive radio sensing measurements, report the passive radio sensing measurements, or receive the one or more partial transmission configurations.

11. The sensing receive device of claim 1, wherein the at least one processor is configured to cause the sensing receive device to receive a sensing measurement configuration from the network device, and wherein the passive radio sensing measurements are performed according to the sensing measurement configuration and the received one or more partial transmission configurations.

12. (canceled)

13. An A sensing controller device for wireless communication, comprising:
at least one memory; and
at least one processor coupled with the at least one memory and configured to cause the sensing controller device to:
receive, from one or more sensing receive devices, capability information that indicates a capability of a sensing receive device to perform passive radio sensing measurements;
transmit, to a first subset of the one or more sensing receive devices, one or more partial transmission configurations to indicate a radio frequency transmission configuration for performing the passive radio sensing measurements; and
transmit, to a second subset of the one or more sensing receive devices, one or more reporting configurations to indicate a type of the passive radio sensing measurements, reporting transmission resources, and criteria for transmitting a report.

14. The sensing controller device of claim 13, wherein the at least one processor is configured to cause the sensing controller device to:
determine the first subset of the one or more sensing receive devices to receive the one or more partial transmission configurations; and
determine the second subset of the one or more sensing receive devices to receive the one or more reporting configurations.

15. The sensing controller device of claim 13, wherein the at least one processor is configured to cause the sensing controller device to receive the report of the passive radio sensing measurements from a respective one of the one or more sensing receive devices.

16. A method performed by a sensing receive device, the method comprising:
receiving, from a network device, one or more partial transmission configurations that include a subset of parameters defining a transmission configuration of a transmit device;
receiving from the transmit device, one or more transmitted signals according to the received one or more partial transmission configurations; and
transmitting a report of passive radio sensing measurements according to a report configuration, the passive radio sensing measurements determined based at least in part on the one or more transmitted signals from the transmit device according to the received one or more partial transmission configurations.

17. The method of claim 16, further comprising determining the passive radio sensing measurements comprising at least in part deterministic or statistical information of at least one of:
a presence of one or more environment objects;
a location of the one or more environment objects;
a velocity of the one or more environment objects;
a type of the one or more environment objects;
a radar cross section (RCS) of the one or more environment objects;
one or more of a shape, a posture, a composite, or a texture of the one or more environment objects; or
a channel state information (CSI) measurement in one or more of a power domain, an angular azimuth domain, an angular elevation domain, a delay domain, or a doppler domain.

18. The method of claim 16, further comprising receiving the report configuration that indicates generating and transmitting the report, the report configuration including at least one of a set of time, frequency, and beam resources for transmitting the report, criteria for transmitting the report, or a type of information included in the report.

19. The method of claim 16, further comprising transmitting a capability indication to at least one of perform one or more types of the passive radio sensing measurements, report the passive radio sensing measurements, or receive the one or more partial transmission configurations.

20. The method of claim 16, further comprising:
receiving, from the network device, a sensing measurement configuration; and
performing the passive radio sensing measurements according to the sensing measurement configuration and the received one or more partial transmission configurations.

21. A method performed by a sensing controller device, the method comprising:
receiving, from one or more sensing receive devices, capability information that indicates a capability of a sensing receive device to perform passive radio sensing measurements;
transmitting, to a first subset of the one or more sensing receive devices, one or more partial transmission configurations to indicate a radio frequency transmission configuration for performing the passive radio sensing measurements; and
transmitting, to a second subset of the one or more sensing receive devices, one or more reporting configurations to indicate a type of the passive radio sensing measurements, reporting transmission resources, and criteria for transmitting a report.
